(19) United States
(12) Patent Application Publication
(10) Pub. No.: US 2015/0150010 A1
(43) Pub. Date: May 28, 2015

(54) METHOD OF EXECUTING ORDERED TRANSACTIONS IN MULTIPLE THREADS, COMPUTER FOR EXECUTING THE TRANSACTIONS, AND COMPUTER PROGRAM THEREFOR

(71) Applicant: International Business Machines Corporation, Armonk, NY (US)

(72) Inventor: Rei Odaira, Tokyo (JP)

(21) Appl. No.: 14/551,161

(22) Filed: Nov. 24, 2014

(30) Foreign Application Priority Data
Nov. 28, 2013 (JP) 2013-245787

(51) Int. Cl. G06F 9/46; G06F 9/52

(52) U.S. Cl. CPC G06F 9/466; G06F 9/522
USPC 718/101

(57) ABSTRACT

Techniques to prevent a chain of or frequent occurrence of aborts when ordered transactions are executed in multiple threads. Executing ordered transactions in multiple threads with detection of occurrence of an abort in at least one of the transactions in the multiple threads and the barrier synchronization of at least two threads including a thread in which the abort is detected.

### BACKGROUND OF THE INVENTION

The present invention relates to a technique for executing ordered transactions in multiple threads.

As a method of speculatively parallelizing single-threaded programs to speed up the single-threaded programs, there is thread-level speculation (TLS). In thread-level speculation, each iteration of a loop is assigned to a separate thread, and the iterations are executed in parallel. Each iteration is executed as a different transaction for purposes of detecting memory data dependence between iterations during execution. Therefore, each transaction needs to be committed in the same order as that in single threaded execution in order to ensure the same execution results as the single threaded execution in thread-level speculation. Ordered transactions are required to execute thread-level speculation, and special hardware that supports the ordered transactions has been used so far.

### SUMMARY

According to an aspect of the present invention, a method (and/or a computer program) executes ordered transactions in multiple threads by the following operations (which may, or may not be performed in the order set forth): (i) running a plurality of threads; (ii) detecting that an abort has occurred in a first transaction in a first thread of the multiple threads; and (iii) performing barrier synchronization of at least two threads including the first thread.

According to a further aspect of the present invention, a computer for executes ordered transactions in multiple threads. The computer includes: (i) an abort detector structured and/or programmed to detect that an abort has occurred in at least one of transactions of the respective threads; and (ii) a barrier synchronator programmed and/or structured to perform barrier synchronization of at least two threads including a thread in which the abort is detected.

### BRIEF DESCRIPTION OF THE DRAWINGS

FIG. 1 is a diagram showing a computer used in an embodiment of the present invention.

FIG. 2A shows a first example (hereinafter called example 1″) according to the embodiment of the present invention, indicating an aspect in which, in response to the occurrence of an abort of one transaction among transactions in multiple threads, all threads are barrier synchronized until transactions being processed when the abort is detected are all committed in order to prevent a chain of aborts.

FIG. 2B shows a second (hereinafter called example 2″) according to the embodiment of the present invention, indicating an aspect in which an abort rate is calculated during the execution of a program with each transaction largely varying in execution time, and in response to the occurrence of an abort of one transaction among transactions in multiple threads, all the threads are barrier synchronized on condition that the measured abort rate is lower than a predetermined threshold value until transactions being processed when the abort is detected are all committed in order to prevent a chain of aborts.

FIG. 3A shows at third example (hereinafter called example 3″) according to the embodiment of the present invention, indicating an aspect in which, in response to the occurrence of an abort of one transaction among transactions in multiple threads, all the threads are barrier synchronized until transactions being processed when the abort is detected are all aborted in order to prevent a chain of aborts.

FIG. 3B shows a fourth example (hereinafter called example 4″) according to the embodiment of the present invention, indicating an aspect in which an abort rate is calculated during the execution of a program with each transaction largely varying in execution time, and in response to the occurrence of an abort of one transaction among transactions in multiple threads, all the threads are barrier synchronized on condition that the measured abort rate is lower than the predetermined threshold value until transactions being processed when the abort is detected are all aborted in order to prevent a chain of aborts.

FIG. 4A shows a fifth example (hereinafter called example 5″) according to the embodiment of the present invention, indicating an aspect in which, in response to the occurrence of an abort of one transaction among transactions in multiple threads, all but one or more threads coming later in the order of execution of transactions are barrier synchronized until transactions in all but one or more threads coming later in the order of execution of transactions being processed when the abort is detected are all committed in order to prevent a chain of aborts.

FIG. 4B shows a sixth example (hereinafter called example 6) according to the embodiment of the present invention, indicating an aspect in which an abort rate is calculated during the execution of a program with each transaction largely varying in execution time, and in response to the occurrence of an abort of one transaction among transactions in multiple threads, all but one or more threads coming later in the order of execution of transactions are barrier synchronized on condition that the measured abort rate is lower than the predetermined threshold value until transactions in all but one or more threads coming later in the order of execution of transactions being processed when the abort is detected are all committed in order to prevent a chain of aborts.

FIG. 5A shows a seventh example (hereinafter called example 7″) according to the embodiment of the present invention, indicating an aspect in which, in response to the occurrence of an abort of one transaction among transactions in multiple threads, all but one or more threads coming later in the order of execution of transactions are barrier synchronized until transactions in all but one or more threads coming later in the order of execution of transactions being processed when the abort is detected are all aborted in order to prevent a chain of aborts.

FIG. 5B shows an eighth example (hereinafter called example 8″) according to the embodiment of the present invention, indicating an aspect in which an abort rate is calculated during the execution of a program with each transaction largely varying in execution time, and in response to the occurrence of an abort of one transaction among transactions in multiple threads, all but one or more threads coming later in the order of execution of transactions are barrier synchronized on condition that the measured abort rate is lower than the predetermined threshold value until transactions in all but one or more threads coming later in the order of execution of transactions being processed when the abort is detected are all aborted in order to prevent a chain of aborts.

FIG. 6A shows a flowchart for implementing example 1 according to the embodiment of the present invention.

FIG. 6B shows a flowchart for implementing example 2 according to the embodiment of the present invention.

FIG. 7A shows a flowchart for implementing example 3 according to the embodiment of the present invention.

FIG. 7B shows a flowchart for implementing example 4 according to the embodiment of the present invention.

FIG. 8A shows a flowchart for implementing example 5 according to the embodiment of the present invention.

FIG. 8B shows a flowchart for implementing example 6 according to the embodiment of the present invention.

FIG. 9A shows a flowchart for implementing example 7 according to the embodiment of the present invention.

FIG. 9B shows a flowchart for implementing example 8 according to the embodiment of the present invention.

FIG. 10 shows benchmark results from examples 1 and 2.

FIG. 11A shows an example of code for implementing the example 1 according to the embodiment of the present invention.

FIG. 11B shows an example of code for implementing the example 2 according to the embodiment of the present invention.

FIG. 12 is a functional block diagram showing an example of a computer that preferably has a hardware configuration according to FIG. 1 to execute ordered transactions in multiple threads according to an embodiment of the present invention.

FIG. 13 shows a conventional technique for execution of each transaction by a single thread and thread-level speculation execution by multiple threads.

FIG. 14 shows a conventional method with simple implementation of ordered transactions using the function of a hardware transactional memory mounted on a normal processor.

FIG. 15 shows a flowchart corresponding to the conventional method of FIG. 14.

### DETAILED DESCRIPTION

Some embodiments of the present invention use “barrier synchronization” in dealing with issues that may arise when simultaneously executing multiple threads. “Barrier synchronization” means that transactions are executed in a designated set of barrier synchronized threads until these transactions are committed or aborted in all of the barrier synchronized threads, or all but a specific thread, but the execution does not further proceed until all the transactions in the barrier synchronized threads are committed or aborted. In various embodiments of the present invention, and as will be discussed in detail, below, barrier synchronization is used upon detection of various conditions, such as abort conditions. The set of barrier synchronized threads may be: (i) all of the threads system-wide; or (ii) fewer than all threads system-wide (but often including the particular thread who's condition triggered the barrier synchronization). A “barrier synchronator,” as that term is used herein, refers to any set of hardware, software and/or firmware structured and/or programmed to perform barrier synchronization.

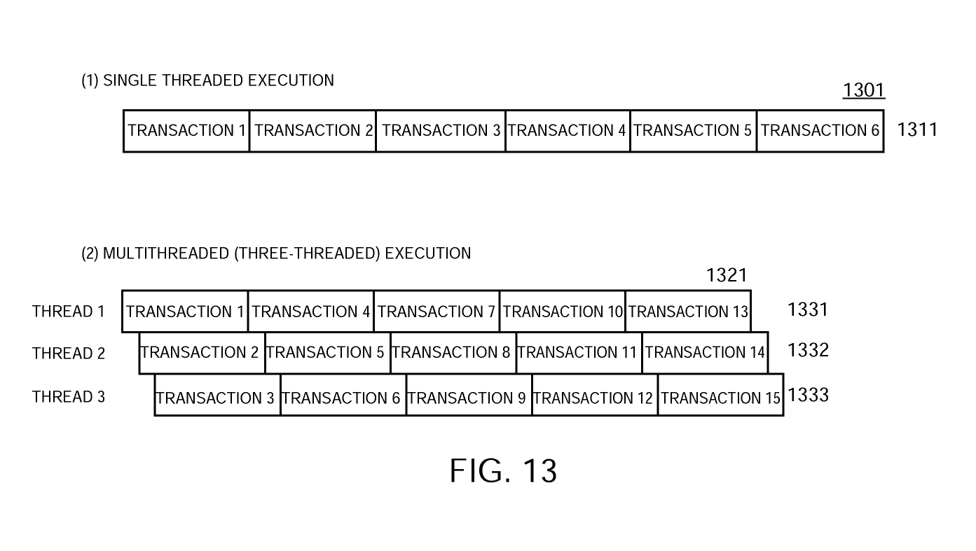

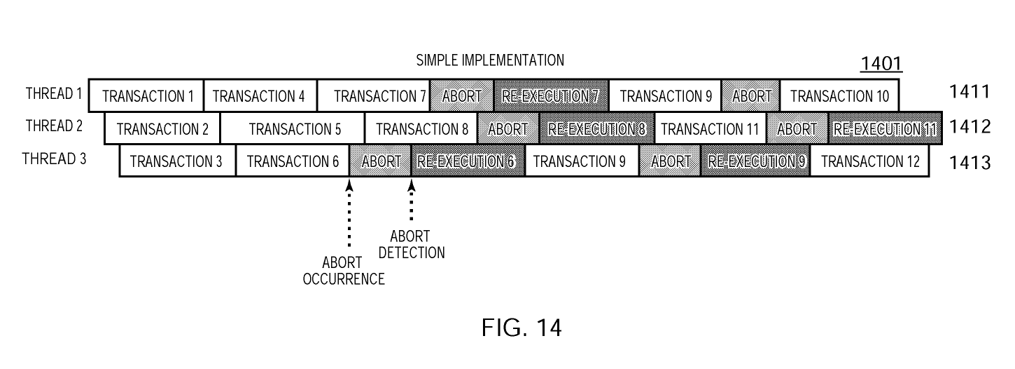

In order to better understand differences between some embodiments of the present invention and currently conventional techniques, some conventional techniques will be discussed in the following paragraphs with reference to FIGS. 13 to 15.

In FIGS. 13 to 15, “(1) single threaded execution” 1301 indicates the execution of each transaction by a single thread 1311. In the execution of each transaction by the single thread, each transaction is executed and committed in the numerical order of transactions like transactions 1, 2, 3, and so on.

In FIGS. 13 to 15, “(2) multithreaded (three-threaded) execution” 1321 indicates thread-level speculation execution by multiple threads 1331, 1332, and 1333) the number of which is three. In the thread-level speculation execution, respective transactions are executed in respective threads in parallel, but the transactions must be committed in the numerical order of transactions like transactions 1, 2, 3, and so on.

Some embodiments of the present invention provide a technique for executing ordered transactions in multiple threads. The technique includes a method of executing the transactions, and a computer, computer program, and computer program product for executing the transactions.

Those skilled in the art will readily appreciate that, with respect to the specific embodiments of the present invention to be described below, various changes can be made, such as to combine each of hardware components of the computer used in the embodiment of the present invention with multiple machines to distribute functions thereto in order to execute the functions. Such changes will, of course, be the concepts included in the spirit of the present invention. However, these components are just illustrative examples, and not all the components are essential components of the present invention. The computer readable storage medium can be a tangible device that can retain and store instructions for use by an instruction execution device. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Further, the present invention may be implemented in hardware, software, or a combination of hardware and software. In the case of a combination of hardware and software, an implementation in a computer on which the above computer program is installed is a typical example. In such a case, the computer program is loaded into a memory of the computer and executed thereon. The computer program controls the computer to perform processing of the method according to the embodiment of the present invention. The computer program may be made up of a set of instructions representable in any language, code, or notation. Such a set of instructions may be executed when the computer executes specific functions directly or after either or both of (1) conversion to any other language, code, or notation, and (2) copy to another medium is made, to perform processing according to the embodiment of the present invention.

According to some embodiments of the present invention, a chain of or frequent occurrence of aborts can be prevented when ordered transactions are executed in multiple threads, resulting in the improvement of performance.

An embodiment of the present invention will be described below with reference to the accompanying drawings. Throughout the drawings, the same reference numerals denote the same objects unless otherwise noted. It should be appreciated that the embodiment of the present invention is to describe a preferred mode of the present invention, and is not intended to limit the scope of the present invention.

A computer usable in the embodiment of the present invention is not particularly limited as long as it can execute ordered transactions in multiple threads. For example, executing ordered transactions in multiple threads may include executing transactions by thread-level speculation. The computer may be, for example, a server computer, a desktop computer, a laptop computer or an all-in-one computer, or a tablet terminal or a smartphone.

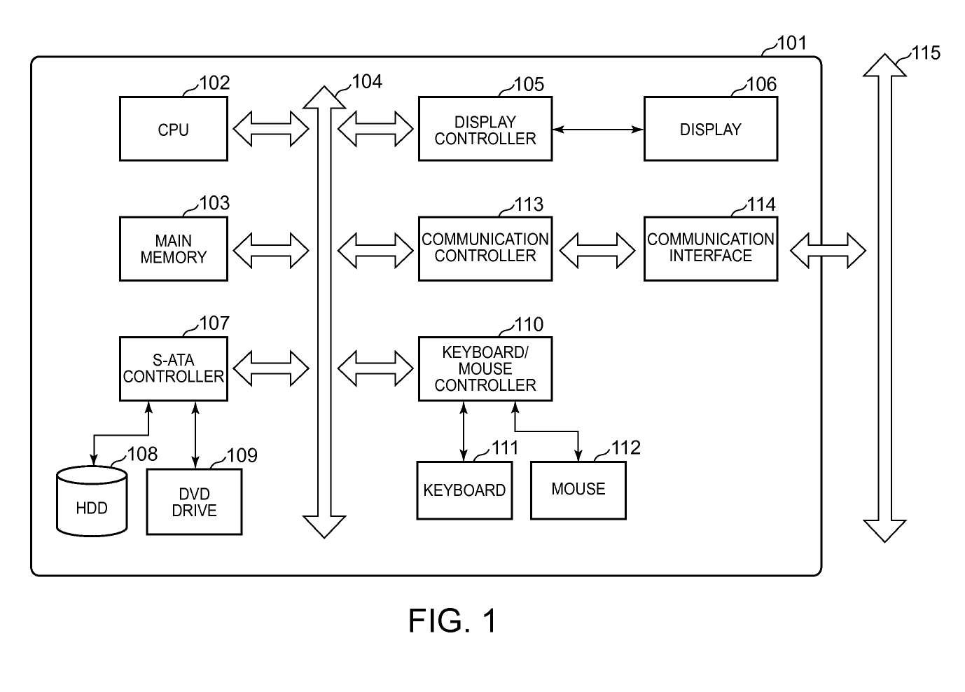

FIG. 1 is a diagram showing an example of the computer usable in the embodiment of the present invention.

A computer 101 includes a CPU 102 and a main memory 103, which are connected to a bus 104. It is preferred that the CPU 102 be based on a 32-bit or 64-bit architecture.

A display 106 such as a liquid crystal display (LCD) can be connected to the bus 104 through a display controller 105. The liquid crystal display (LCD) may be, for example, a touch panel display or a floating touch display. The display 106 can be used to display, via an appropriate graphic interface, objects to be displayed by operating software running on the computer 101 (e.g., a computer program according to the embodiment of the present invention or any of various computer programs running on the computer 101). Further, the display 106 can output an abort rate measured according to the embodiment of the present invention.

A disk 108 such as a hard disk or solid-state drive (SSD) can be optionally connected to the bus 104 through a currently conventional type of disk controller 107. A drive 109 such as a CD (compact disc), DVD (digital video disk), or BD (blue ray type disk) drive can be optionally connected to the bus 104 through controller 107.

Further, a keyboard 111 and a mouse 112 can be optionally connected to the bus 104 through a keyboard/mouse controller 110 or a USB (universal serial bus) data communication connection.

An operating system, a computer program according to the embodiment of the present invention, other programs, and data can be stored on the disk 108 in a manner to be able to be loaded into the main memory 103. The disk 108 may be incorporated in the computer 101, connected through a cable to be accessible by the computer 101, or connected through a wired or wireless network to be accessible by the computer 101.

The drive 109 can be used to install a program, such as the operating system, an application, or the computer program according to the embodiment of the present invention, from a CD-ROM (note: ROM stands for read only memory), a DVD-ROM, or a BD onto the disk 108 as required.

A communication interface 114 follows, for example, any currently conventional protocol, or any suitable protocol to be developed in the future. The communication interface 114 is connected to the bus 104 through a communication controller 113 to take a role in connecting the computer 101 to a communication line 115) by wire or wireless, providing a network interface layer to the TCP/IP (Transmission Control Protocol/Internet Protocol) communication protocol as the communication function of the operating system on the computer 101. The communication line may be, for example, a wireless LAN environment based on a wireless LAN standard such as IEEE802.11a/b/g/n, a Wi-Fi wireless LAN (large area network) environment, or a cellular phone network environment (e.g., 3G or 4G environment).

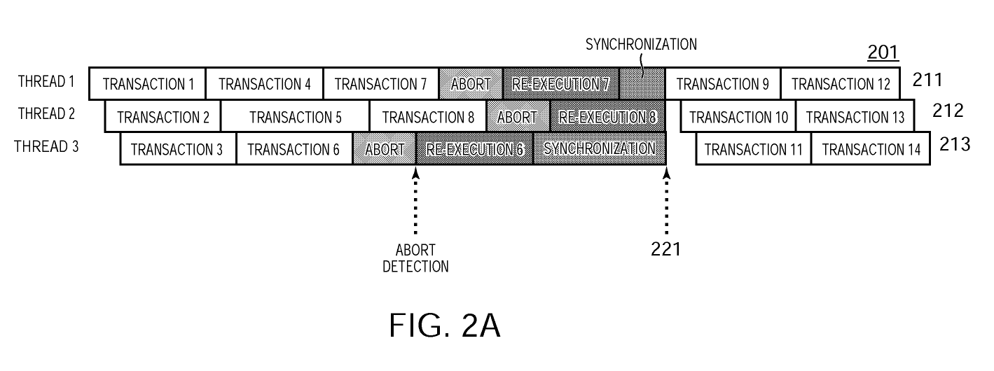

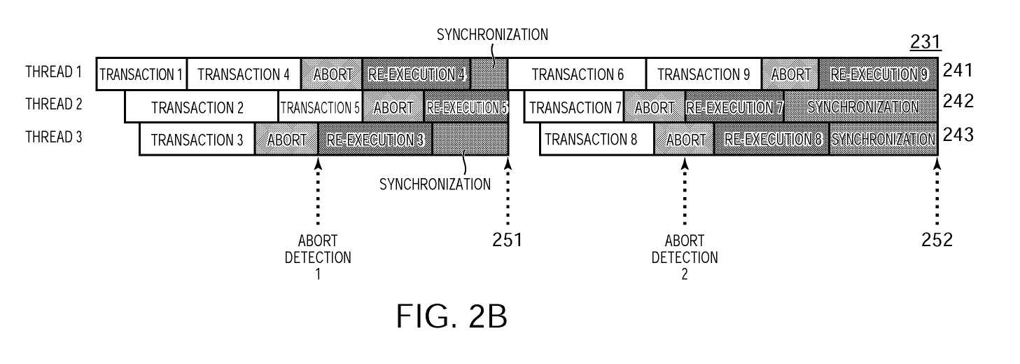

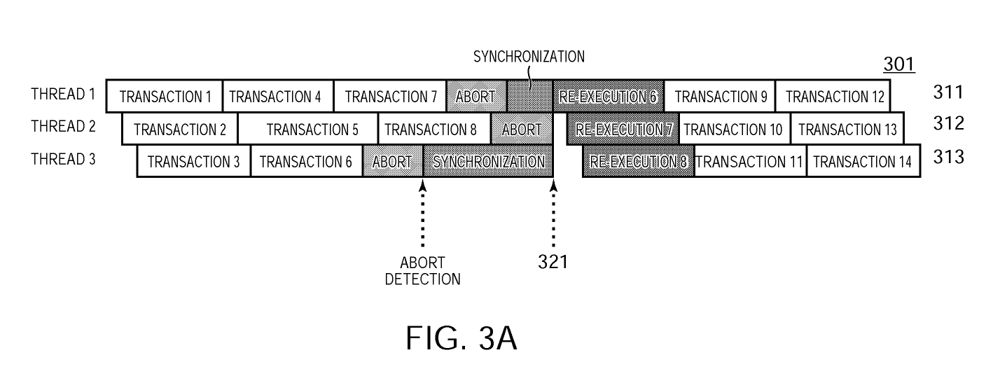

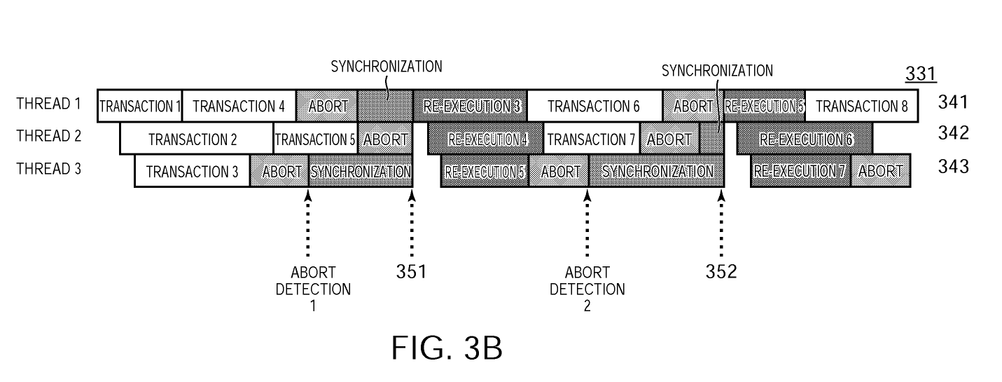

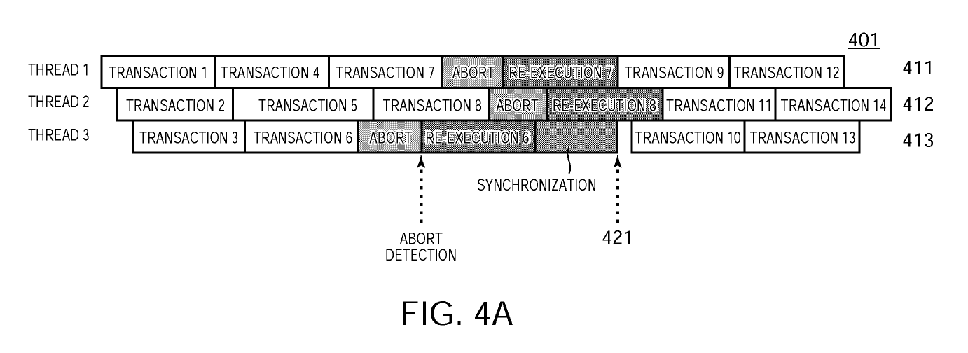

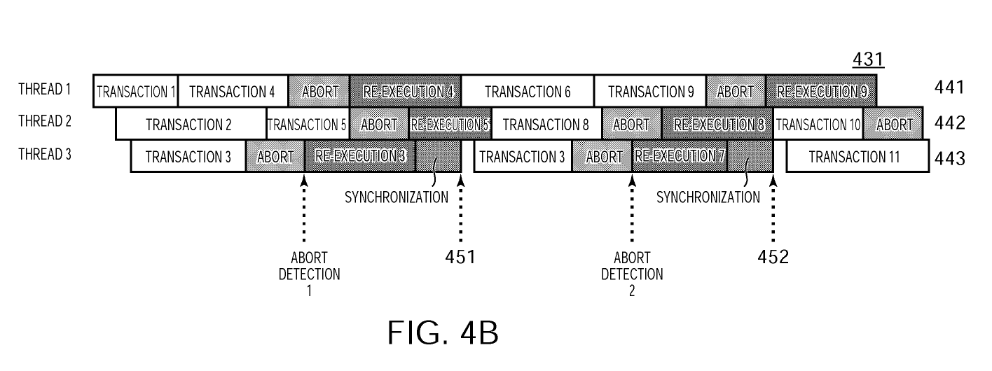

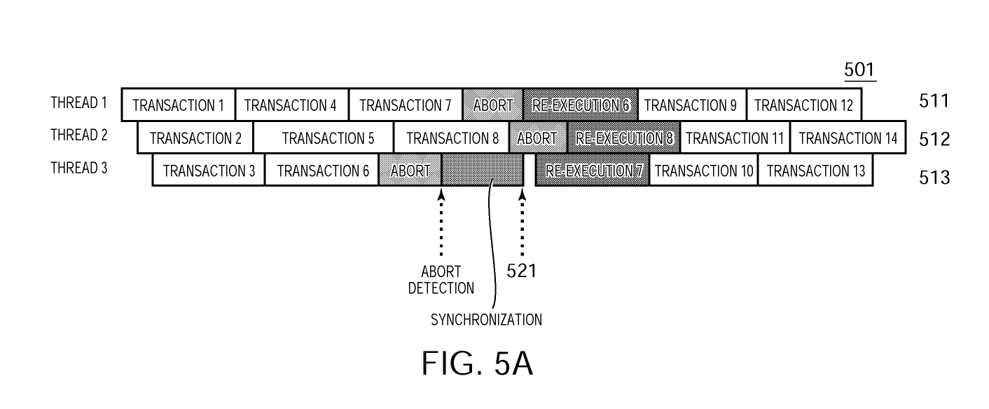

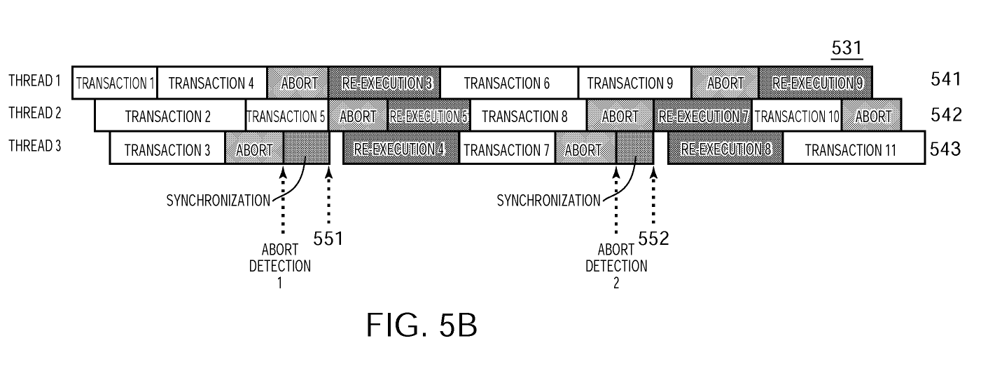

FIG. 2A and FIG. 2B, FIG. 3A and FIG. 3B, FIG. 4A and FIG. 4B, and FIG. 5A and FIG. 5B mentioned below show various embodiments of the present invention, respectively, taking a case where it is detected that an abort has occurred in at least one of transactions of the respective threads, and at least two threads including the thread in which the abort is detected are barrier synchronized. Note that, although the number of threads is three in the embodiment for ease of description, the number of threads is not limited as long as the number is plural. Note further that the execution time, the execution order, and the abort time of each transaction in the embodiment are not limited to the lengths shown.

The “barrier synchronization” in the embodiment of the present invention means that transactions are executed in multiple threads until they are committed or aborted in all threads or all but a specific thread, but the execution does not further proceed until all the transactions are committed or aborted.

FIG. 2A shows example 1 according to the embodiment of the present invention. In the example 1, in response to the occurrence of an abort in one transaction among transactions in the multiple threads, all threads are barrier synchronized until all transactions being processed (being executed or aborted) when the abort is detected are committed.

FIG. 2A shows that transactions are being executed in thread 1 to thread 3 (211, 212, and 213), respectively. It is assumed that the transactions do not vary in execution time very much from each other (also called uniform transactions).

Since a transaction 5 (thread 2 (212)) having number 5 preceding a transaction 6 has not been completed just before the end of the transaction 6 in the thread 3 (213), the computer 101 determines that it is not the turn of the transaction 6 to be committed. In response to the fact that it is not the turn of the transaction 6 to be committed, the computer 101 aborts the transaction 6. In response to the detection of the abort, the computer 101 sets a barrier synchronization flag for barrier synchronization of all threads. Then, the computer 101 re-executes the transaction 6 (shown as “RE-EXECUTION 6”). Since the re-execution 6 is completed in the thread 3 (213) (i.e., the re-execution 6 is committed) and the barrier synchronization flag is set, the computer 101 waits without processing the next transaction in the thread 3 (213) until barrier synchronization 221) of all the threads is performed. In other words, since the barrier synchronization flag is set, the computer 101 performs barrier synchronization 221) of all the threads 211 to 213) until transactions (transaction 6, and transaction 7 and transaction 8 mentioned below) being processed (being executed or aborted) in all the threads 211 to 213) when the abort is detected are all committed.

After the abort of the transaction 6 occurs in the thread 3 (213) as mentioned above, the computer 101 detects the occurrence of the abort at a time point (ABORT DETECTION) shown in FIG. 2A.

When the abort in the thread 3 (213) is detected, the computer 101 is executing a transaction 7 in the thread 1 (211). Since the transaction 6 (thread 3 (213)) having number 6 preceding the transaction 7 has not been completed just before the end of the transaction 7, the computer 101 determines that it is not the turn of the transaction 7 to be committed. In response to the fact that it is not the turn of the transaction 7 to be committed, the computer 101 aborts the transaction 7. In response to the detection of the abort, the computer 101 sets the barrier synchronization flag for barrier synchronization of all threads (this is an embodiment in which even when the barrier synchronization flag is already set, the barrier synchronization flag is set again), or considers that it has set the barrier synchronization flag because the flag is already set, to re-execute the above transaction 7 (shown as “RE-EXECUTION 7”). Since the re-execution 7 is completed (i.e., the re-execution 7 is committed) and the barrier synchronization flag is set, the computer 101 waits without processing the next transaction in the thread 1 (211) until all the threads 211 to 213) are barrier synchronized. In other words, since the barrier synchronization flag is set, the computer 101 performs barrier synchronization 221) of all the threads 211 to 213) until transactions (transaction 6, transaction 7, and transaction 8 mentioned below) being processed (being executed or aborted) in all the threads 211 to 213) when the abort is detected are all committed.

When the abort in the thread 3 (213) is detected, the computer 101 is executing a transaction 8 in the thread 2 (212). Since the transaction 7 (thread 1 (211)) having number 7 preceding the transaction 8 has not been completed just before the end of the transaction 8, the computer 101 determines that it is not the turn of the transaction 8 to be committed. In response to the fact that it is not the turn of the transaction 8 to be committed, the computer 101 aborts the transaction 8. In response to the detection of the abort, the computer 101 sets the barrier synchronization flag for barrier synchronization of all the threads, or considers that it has set the barrier synchronization flag because the barrier synchronization flag is already set, to re-execute the transaction 8 (shown as “RE-EXECUTION 8”). In response to the completion of the re-execution 8 (i.e., in response to the fact that the re-execution 8 is committed), the computer 101 clears the barrier synchronization flag because the barrier synchronization flag is set and all transactions (transaction 6, transaction 7, and transaction 8) being processed (being executed or aborted) when the abort is detected are committed.

In response to the fact that the barrier synchronization flag is cleared, the computer 101 ends the barrier synchronization 221) and resumes transaction processing in all the threads 211 to 213). Note that, although FIG. 2A shows that the computer 101 executes a transaction 9 in the thread 1 (211), then executes a transaction 10 in the thread 2 (212), and then executes a transaction 11 in the thread 3 (213), it is optional which thread executes which transaction, and it is not limited to those mentioned above.

In the example 1 mentioned above, the barrier synchronization 221) of all the threads 211 to 213) is performed until transactions being executed when the abort in the thread 3 (213) is detected are all committed, thereby preventing a chain of aborts.

FIG. 2B shows example 2 according to the embodiment of the present invention. In the example 2, an abort rate is calculated from transactions that largely vary in execution time from each other (also called non-uniform transactions), and in response to the occurrence of an abort in one transaction among transactions in multiple threads, all the threads are barrier synchronized on condition that the measured abort rate is lower than a predetermined threshold value until transactions being processed (being executed or aborted) when the abort is detected are all committed.

FIG. 2B shows that transactions are being executed in thread 1 to thread 3 (241, 242, and 243), respectively. It is assumed that the transactions largely vary in execution time from each other (also called non-uniform transactions).

Since a transaction 2 (thread 2 (242)) having number 2 preceding a transaction 3 has not been completed just before the end of the transaction 3 in the thread 3 (243), the computer 101 determines that it is not the turn of the transaction 3 to be committed. In response to the fact that it is not the turn of the transaction 3 to be committed, the computer 101 aborts the transaction 3. In response to the detection of the abort, the computer 101 sets the barrier synchronization flag for barrier synchronization of all threads. Then, the computer 101 re-executes the transaction 3 (shown as “RE-EXECUTION 3”). Since the transaction 2 (thread 2 (242)) having number 2 preceding the re-execution 3 has been completed just before the end of the re-execution 3, the computer 101 commits the re-execution 3. Next, since the barrier synchronization flag is set, the computer 101 waits without processing the next transaction in the thread 3 (243) until barrier synchronization 251 of all the threads 241 to 243) is performed. In other words, since the barrier synchronization flag is set, the computer 101 performs the barrier synchronization 251 of all the threads 241 to 243) until transactions (transaction 3, transaction 4, and transaction 5 mentioned below) being processed (being executed or aborted) in all the thread 241 to 243) when the abort is detected are all committed.

After the abort of the transaction 3 occurs in the thread 3 (243), the computer 101 detects the occurrence of the abort at a time point (ABORT DETECTION 1) shown in FIG. 2B.

When the abort of the transaction 3 in the thread 3 (243) is detected, the computer 101 is aborting a transaction 4 in the thread 1 (241). Since the transaction 3 (thread 3 (243)) having number 3 preceding the transaction 4 has not been completed (being aborted) just before the end of the transaction 4, the computer 101 determines that it is not the turn of the transaction 4 to be committed. In response to the fact that it is not the turn of the transaction 4 to be committed, the computer 101 aborts the transaction 4. In response to the detection of the abort, the computer 101 sets the barrier synchronization flag for barrier synchronization of all threads, or considers that it has set the barrier synchronization flag because the flag is already set, to re-execute the transaction 4 (shown as “RE-EXECUTION 4”). Since the transaction 3 (thread 3 (243)) having number 3 preceding the re-execution 4 has been completed just before the end of the re-execution 4, the computer 101 commits the re-execution 4. Next, since the re-execution 4 is completed (i.e., the re-execution 4 is committed) and the barrier synchronization flag is set, the computer 101 waits without processing the next transaction in the thread 1 (241) until barrier synchronization 251 in all the threads 241 to 243) is performed. In other words, since the barrier synchronization flag is set, the computer 101 performs the barrier synchronization 251 of all the threads 241 to 243) until transactions (transaction 3, transaction 4, and transaction 5) being processed (being executed or aborted) in all the threads 241 to 243) when the abort is detected are all committed.

When the abort of the transaction 3 in the thread 3 (243) is detected, the computer 101 is executing a transaction 5 in the thread 2 (242). Since the transaction 4 (thread 1 (241)) having number 4 preceding the transaction 5 has not been completed being aborted) just before the end of the transaction 5, the computer 101 determines that it is not the turn of the transaction 5 to be committed. In response to the fact that it is not the turn of the transaction 5 to be committed, the computer 101 aborts the transaction 5. In response to the detection of the abort, the computer 101 sets the barrier synchronization flag for barrier synchronization of all the threads, or considers that it has set the barrier synchronization flag, to re-execute the transaction 5 shown as “RE-EXECUTION 5”). Since the transaction 4 (thread 1 (241)) having number 4 preceding the re-execution 5 has been completed just before the end of the re-execution 5, the computer 101 commits the re-execution 5. Then, in response to the fact that the re-execution 5 is completed (i.e., that the re-execution 5 is committed), the computer 101 clears the barrier synchronization flag because the barrier synchronization flag is set and transactions (transaction 3, transaction 4, and transaction 5) being processed (being executed or aborted) in all the threads 241 to 243) when the abort is detected are all committed.

In the example 2 mentioned above, the barrier synchronization 251 of all the threads 241 to 243) is performed until transactions being processed (being executed or aborted) when the abort of the transaction 3 in the thread 3 (243) is detected are all committed, thereby preventing a chain of aborts.

The computer 101 can calculate an abort rate, for example, (1) in response to the detection of the abort of the transaction 3 in the thread 3 (243), (2) in response to the completion of the barrier synchronization 251, (3) at predetermined time intervals, or (4) in response to the fact that a predetermined amount of transactions is processed. The abort rate may be, for example, a value obtained by dividing the number of aborted transactions by the number of committed transactions (including transactions committed by re-execution), or a value obtained by dividing the number of aborted transactions by the number of processed transactions (including re-executions) regardless of whether to be committed or not. Those skilled in the art can arbitrarily select the abort rate mentioned above.

In response to the fact that the barrier synchronization flag is cleared, the computer 101 ends the barrier synchronization 251. Then, in response to the fact that the abort rate is lower than the predetermined threshold value, the computer 101 continuously resumes transaction processing in all the threads 241 to 243). In other words, the computer 101 repeats processing for detecting an abort and performing barrier synchronization. The reason for determining whether the abort rate is lower than the predetermined threshold value is because, when each transaction largely varies in execution time, transaction processing may be made slow by performing the barrier synchronization of all the threads 241 to 243) until transactions being processed (being executed or aborted) when an abort is detected are all committed.

Note that, although FIG. 2B shows that the computer 101 executes a transaction 6 in the thread 1 (241), then executes a transaction 7 in the thread 2 (242), and then executes a transaction 8 in the thread 3 (243), it is optional which thread executes which transaction, and it is not limited to those mentioned above.

Then, since the transaction 6 (thread 1 (241)) having number 6 preceding transaction 7 has not been completed just before the end of the transaction 7 in the thread 2 (242), the computer 101 determines that it is not the turn of the transaction 7 to be committed. In response to the fact that it is not the turn of the transaction 7 to be committed, the computer 101 aborts the transaction 7. In response to the detection of the abort, the computer 101 sets the barrier synchronization flag for barrier synchronization of all the threads 241 to 243). Then, the computer 101 re-executes the transaction 7 (shown as “RE-EXECUTION 7”). Since the transaction 6 (thread 1 (241)) having number 6 preceding the re-execution 7 has been completed just before the end of the re-execution 7, the computer 101 commits the re-execution 7. Next, since the barrier synchronization flag is set, the computer 101 waits without processing the next transaction in the thread 2 (242) until barrier synchronization 252) of all the threads 241 to 243) is performed. In other words, since the barrier synchronization flag is set, the computer 101 performs the barrier synchronization 252) of all the threads 241 to 243) until transactions (transaction 7, transaction 8, and transaction 9 mentioned below) being processed (being executed or aborted) in all the threads 241 to 243) when the abort is detected are all committed.

After the abort of the transaction 7 occurs in the thread 2 (242), the computer 101 detects the occurrence of the abort at a time point (ABORT DETECTION 2) shown in FIG. 2B.

When the abort of the transaction 7 in the thread 2 (242) is detected, the computer 101 is aborting the transaction 8 in the thread 3 (243). Since the transaction 7 (thread 2 (242)) having number 7 preceding the transaction 8 just before the end of the transaction 8 has not been completed (being aborted), the computer 101 determines that it is not the turn of the transaction 8 to be committed. In response to the fact that it is not the turn of the transaction 8 to be committed, the computer 101 aborts the transaction 8. In response to the detection of the abort, the computer 101 sets the barrier synchronization flag for barrier synchronization of all the threads, or considers that it has set the barrier synchronization flag because the above barrier synchronization flag is already set, to re-execute the transaction 8 (shown as “RE-EXECUTION 8”). Since the re-execution 7 (thread 2 (242)) having number 7 preceding the re-execution 8 has been completed just before the end of the re-execution 8, the computer 101 commits the re-execution 8. Next, since the re-execution 8 is completed (i.e., the re-execution 8 is committed) and the barrier synchronization flag is set, the computer 101 waits without processing the next transaction in the thread 3 (243) until the barrier synchronization 252) of all the threads 241 to 243) is performed. In other words, since the barrier synchronization flag is set, the computer 101 performs the barrier synchronization 252) of all the threads 241 to 243) until transactions (transaction 6, transaction 7, and transaction 8) being processed (being executed or aborted) in all the threads 241 to 243) when the abort is detected are all committed.

When the abort of the transaction 7 in the thread 2 (242) is detected, the computer 101 is executing a transaction 9 in the thread 1 (241). Since the transaction 8 (thread 3 (243)) having number 8 preceding the transaction 9 have not been completed (being aborted) just before the end of the transaction 9, the computer 101 determines that it is not the turn of the transaction 9 to be committed. In response to the fact that it is not the turn of the transaction 9 to be committed, the computer 101 aborts the transaction 9. In response to the detection of the abort, the computer 101 sets the barrier synchronization flag for barrier synchronization of all the threads, or considers that it has set the barrier synchronization flag because the barrier synchronization flag is already set, to re-execute the transaction 9 (shown as “RE-EXECUTION 9”). Since the re-execution 8 (thread 1 (243)) having number 8 preceding the re-execution 9 has been completed just before the end of the re-execution 9, the computer 101 commits the re-execution 9. Then, in response to the fact that the re-execution 9 is completed (i.e., that the re-execution 9 is committed), the computer 101 clears the barrier synchronization flag because the barrier synchronization flag is set and transactions (transaction 6, transaction 7, and transaction 8) being processed (being executed or aborted) in all the threads 241 to 243) when the abort is detected are all committed.

The computer 101 can calculate an abort rate, for example, (1) in response to the detection of the abort of the transaction 7 in the thread 2 (242), (2) in response to the completion of the barrier synchronization 252), (3) at predetermined time intervals, or (4) in response to the fact that a predetermined amount of transactions is processed.

In response to the fact that the barrier synchronization flag is cleared, the computer 101 ends the barrier synchronization 252). Then, in response to the fact that the abort rate is lower than the predetermined threshold value, the computer 101 continuously resumes transaction processing in all the threads 241 to 243) (not shown). In other words, the computer 101 repeats processing for detecting an abort and performing barrier synchronization.

In the example 2 mentioned above, in response to the fact that the abort rate is lower than the predetermined threshold value, the barrier synchronization 252) of all the threads 241 to 243) is performed until transactions being processed (being executed or aborted) when the abort of the transaction 7 in the thread 2 (242) is detected are all committed, thereby preventing a chain of aborts.

FIG. 3A shows example 3 according to the embodiment of the present invention. In the example 3, in response to the occurrence of an abort in one transaction among transactions in multiple threads, all threads are barrier synchronized until transactions being processed (being executed or aborted) when the abort is detected are all committed.

FIG. 3A shows that transactions are being executed in thread 1 to thread 3 (311, 312, and 313), respectively. It is assumed that the transactions do not vary in execution time very much from each other (also called uniform transactions).

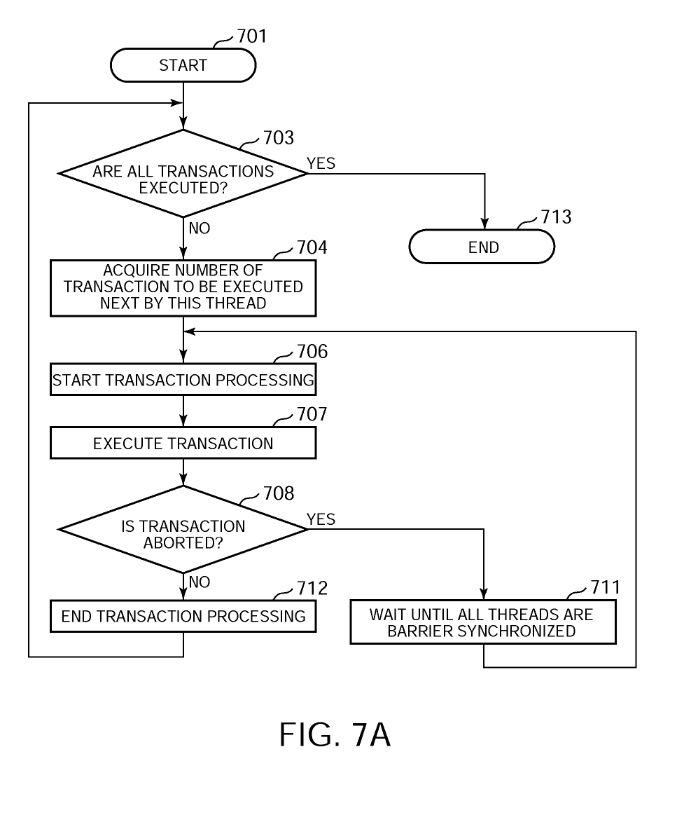

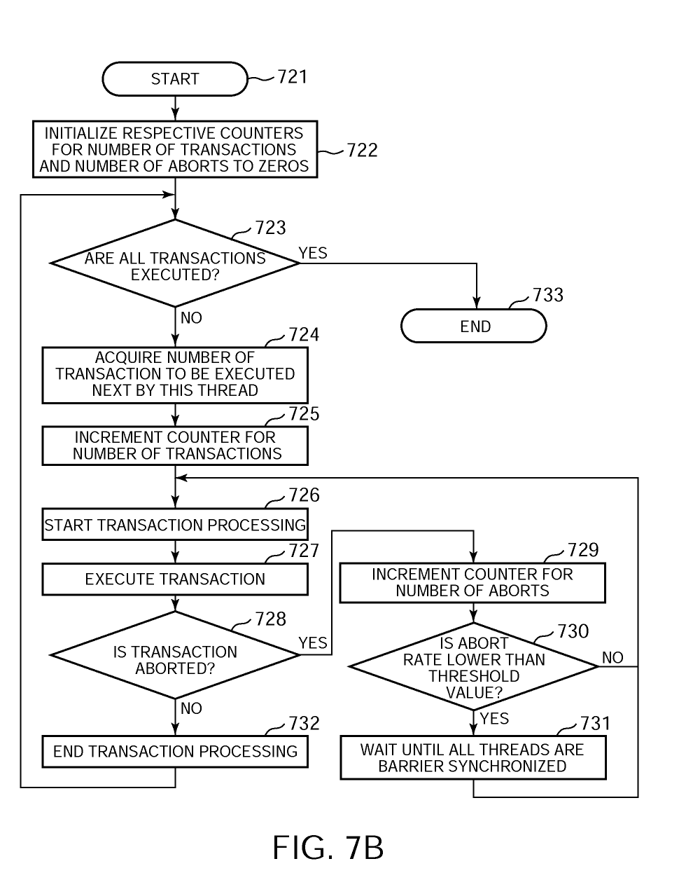

Since a transaction 5 (thread 2 (312)) having number 5 preceding a transaction 6 has not been completed just before the end of the transaction 6 in the thread 3 (313), the computer 101 determines that it is not the turn of the transaction 6 to be committed. In response to the fact that it is not the turn of the transaction 6 to be committed, the computer 101 aborts the transaction 6. In response to the detection of the abort, the computer 101 waits without processing the next transaction in the thread 3 (313) until barrier synchronization 321) of all the threads 311 to 313) is performed. In other words, the computer 101 performs the barrier synchronization 321) of all the threads 311 to 313) until transactions (transaction 6, and transaction 7 and transaction 8 mentioned below) being processed (being executed or aborted) in all the threads 311 to 313) when the abort is detected are all aborted. In the example 3, since the step of determining whether to perform the barrier synchronization and the step of actually performing the barrier synchronization are the same (see step 711 in FIG. 7A to be mentioned later), the barrier synchronization flag for barrier synchronization of all threads does not always have to be set.

After the abort of the transaction 6 occurs in the thread 3 313), the computer 101 detects the occurrence of the abort at a time point (ABORT DETECTION) shown in FIG. 3A.

When the abort of the transaction 6 in the thread 3 (313) is detected, the computer 101 is executing a transaction 7 in the thread 1 (311). Since the transaction 6 (thread 3 (313)) having number 6 preceding the transaction 7 has not been completed (being barrier synchronized) just before the end of the transaction 7, the computer 101 determines that it is not the turn of the transaction 7 to be committed. In response to the fact that it is not the turn of the transaction 7 to be committed, the computer 101 aborts the transaction 7. The computer 101 waits without processing the next transaction in the thread 1 (311) until the barrier synchronization 321) of all the threads 311 to 313) is performed. In other words, the computer 101 performs the barrier synchronization 321) of all the threads 311 to 313) until transactions (transaction 6, transaction 7, and transaction 8 mentioned below) being processed (being executed or aborted) in all the threads 311 to 313) when the abort is detected are all aborted.

When the abort of the transaction 6 in the thread 3 (313) is detected, the computer 101 is executing a transaction 8 in the thread 2 (312). Since the transaction 7 (thread 1 (311)) having number 7 preceding the transaction 8 has not been completed (being executed) just before the end of the transaction 8, the computer 101 determines that it is not the turn of the transaction 8 to be committed. In response to the fact that it is not the turn of the transaction 8 to be committed, the computer 101 aborts the transaction 8.

In response to the fact that the transaction 8 is aborted, the computer 101 ends the barrier synchronization 321) because transactions (transaction 6, transaction 7, and transaction 8) being processed (being executed or aborted) when the abort of the transaction 6 in the thread 3 (313) is detected are all aborted.

In response to the completion of the barrier synchronization 321), the computer 101 resumes transaction processing in all the threads 311 to 313). In other words, the computer 101 repeats processing for detecting an abort and performing barrier synchronization.

Note that, although FIG. 3A shows that the computer 101 re-executes the transaction 6 in the thread 1 (311) (shown as “RE-EXECUTION 6”), then re-executes the transaction 7 in the thread 2 (312) (shown as “RE-EXECUTION 7”), and then re-executes the transaction 8 in the thread 3 (313) (shown as “RE-EXECUTION 8”), it is optional which thread executes which transaction, and it is not limited to those mentioned above.

In the example 3 mentioned above, the barrier synchronization 321) of all the threads 311 to 313) is performed until transactions (transaction 6, transaction 7, and transaction 8) being processed (being executed or aborted) when the abort of the transaction 6 in the thread 3 (313) is detected are all aborted, thereby preventing a chain of aborts.

FIG. 3B shows example 4 according to the embodiment of the present invention. In the example 4, an abort rate is calculated during the execution of a program with transactions largely varying in execution time from each other, and in response to the occurrence of an abort in one transaction among transactions in multiple threads, all the threads are barrier synchronized on condition that the measured abort rate is lower than a predetermined threshold value until transactions being processed (being executed or aborted) when the abort is detected are all aborted.

FIG. 3B shows that transactions are being executed in thread 1 to thread 3 (341, 342, and 343), respectively. It is assumed that the transactions largely vary in execution time from each other (also called non-uniform transactions).

Since a transaction 2 (thread 2 (342)) having number 2 preceding a transaction 3 has not been completed just before the end of the transaction 3 in the thread 3 (343), the computer 101 determines that it is not the turn of the transaction 3 to be committed. In response to the fact that it is not the turn of the transaction 3 to be committed, the computer 101 aborts the transaction 3. In response to the fact that the transaction 3 in the thread 3 (343) is aborted, the computer 101 waits without processing the next transaction in the thread 3 (343) until barrier synchronization 351) of all the threads 341 to 343) is performed. In other words, the computer 101 performs the barrier synchronization 351) of all the threads 341 to 343) until transactions (transaction 3, and transaction 4 and transaction 5 mentioned below) being processed (being executed or aborted) in all the threads 341 to 343) when the abort is detected are all aborted. In the example 4, since the step of determining whether to perform the barrier synchronization and the step of actually performing the barrier synchronization are the same (see step 731 in FIG. 7B to be mentioned later), the barrier synchronization flag for barrier synchronization of all threads does not always have to be set.

After the abort of the transaction 3 occurs in the thread 3 (343), the computer 101 detects the occurrence of the abort at a time point (ABORT DETECTION 1) shown in FIG. 3B.

When the abort of the transaction 3 in the thread 3 (343) is detected, the computer 101 is aborting a transaction 4 in the thread 1 (341). The computer 101 waits without processing the next transaction in the thread 1 (341) until barrier synchronization 351) of all the threads 341 to 343) is performed. In other words, the computer 101 performs the barrier synchronization 351) of all the threads 341 to 343) until transactions (transaction 3, transaction 4, and transaction 5 mentioned below) being processed (being executed or aborted) in all the threads 341 to 343) when the abort is detected are all aborted.

When the abort of the transaction 3 in the thread 3 (343) is detected, the computer 101 is executing a transaction 5 in the thread 2 (342). Since the transaction 4 (thread 1 (341)) having number 4 preceding the transaction 5 has not been completed (being aborted) just before the end of the transaction 5, the computer 101 determines that it is not the turn of the transaction 5 to be committed. In response to the fact that it is not the turn of the transaction 5 to be committed, the computer 101 aborts the transaction 5.

In response to the fact that the transaction 5 is aborted, the computer 101 ends the barrier synchronization 351) because transactions (transaction 3, transaction 4, and transaction 5) being processed (being executed or aborted) when the abort of the transaction 3 in the thread 3 (343) is detected are all aborted.

In the example 4 mentioned above, the barrier synchronization 351) of all the threads 341 to 343) is performed until transactions being processed (being executed or aborted) when the abort of the transaction 3 in the thread 3 (343) is detected are all aborted, thereby preventing a chain of aborts.

The computer 101 can calculate an abort rate, for example, (1) in response to the detection of the abort of the transaction 3 in the thread 3 (343), (2) in response to the completion of the barrier synchronization 351), (3) at predetermined time intervals, or (4) in response to the fact that a predetermined amount of transactions is processed. Those skilled in the art can arbitrarily select the abort rate defined in the description of FIG. 2B.

In response to the fact that the abort rate is lower than the predetermined threshold value, the computer 101 continuously resumes transaction processing in all the threads 341 to 343). In other words, the computer 101 repeats processing for detecting an abort and performing barrier synchronization. The reason for determining whether the abort rate is lower than the predetermined threshold value is because, when the transactions largely vary in execution time from each other, transaction processing may be made slow by performing the barrier synchronization of all the threads until transactions being processed (being executed or aborted) when the abort is detected are all aborted.

Note that, although FIG. 3B shows that the computer 101 re-executes the transaction 3 in the thread 1 (341) (shown as “RE-EXECUTION 3”), then re-executes the transaction 4 in the thread 2 (342) (shown as “RE-EXECUTION 4”), and then re-executes the transaction 5 in the thread 3 (343) (shown as “RE-EXECUTION 5”), it is optional which thread executes which transaction, and it is not limited to those mentioned above.

Then, since the re-execution 4 (thread 2 (342)) having number 4 preceding the re-execution 5 has not been completed just before the end of the re-execution 5 in the thread 3 (343), the computer 101 determines that it is not the turn of the re-execution 5 to be committed. In response to the fact that it is not the turn of the re-execution 5 to be committed, the computer 101 aborts the re-execution 5. In response to the detection of the abort of the re-execution 5 in the thread 3 (343), the computer 101 waits without processing the next transaction in the thread 3 (343) until barrier synchronization 352) of all the threads 341 to 343) is performed. In other words, the computer 101 performs the barrier synchronization 352) of all the threads 341 to 343) until transactions (re-execution 5, and transaction 6 and transaction 7 mentioned below) being processed (being executed or aborted) in all the threads 341 to 343) when the abort is detected are all aborted.

After the abort of the re-execution 5 occurs in the thread 3 (343), the computer 101 detects the occurrence of the abort at a time point (ABORT DETECTION 2) shown in FIG. 3B.

When the abort of the re-execution 5 in the thread 3 (343) is detected, the computer 101 is executing a transaction 7 in the thread 2 (342). Since a transaction 6 (thread 1 (341)) having number 6 preceding the transaction 7 has not been completed (being executed) just before the end of the transaction 7, the computer 101 determines that it is not the turn of the transaction 7 to be committed. In response to the fact that it is not the turn of the transaction 7 to be committed, the computer 101 aborts the transaction 7. The computer 101 waits without processing the next transaction in the thread 1 (341) until the barrier synchronization 352) of all the threads 341 to 343) is performed. In other words, the computer 101 performs the barrier synchronization 352) of all the threads 341 to 343) until transactions (re-execution 5, transaction 6, and transaction 7 mentioned below) being processed (being executed or aborted) in all the threads 341 to 343) when the abort is detected are all aborted.

When the abort of the re-execution 5 in the thread 3 (343) is detected, the computer 101 is executing the transaction 6 in the thread 1 (341). Since the re-execution 5 (thread 3 (343)) having number 5 preceding the transaction 6 has not been completed (being aborted) just before the end of the transaction 6, the computer 101 determines that it is not the turn of the transaction 6 to be committed. In response to the fact that it is not the turn of the transaction 6 to be committed, the computer 101 aborts the transaction 6.

In response to the fact that the transaction 6 is aborted, the computer 101 ends the barrier synchronization 352) because transactions (re-execution 5, transaction 6, and transaction 7) being processed (being executed or aborted) when the abort of the transaction 3 in the thread 3 (343) is detected are all aborted.

In the example 4 mentioned above, the barrier synchronization 352) of all the threads 341 to 343) is performed in response to the fact that the abort rate is lower than a predetermined threshold value until transactions being processed (being executed or aborted) when the abort of the re-execution 5 in the thread 3 (343) is detected are all aborted, thereby preventing a chain of aborts.

The computer 101 can calculate the abort rate, for example, (1) in response to the detection of the abort of the re-execution 5 in the thread 3 (343), (2) in response to the completion of the barrier synchronization 352), (3) at predetermined time intervals, or (4) in response to the fact that a predetermined amount of transactions is processed.

In response to the fact that the abort rate is lower than the predetermined threshold value, the computer 101 continuously resumes transaction processing in all the threads 341 to 343). In other words, the computer 101 repeats processing for detecting an abort and performing barrier synchronization.

Note that, although FIG. 3B shows that the computer 101 re-executes the transaction 5 in the thread 1 (341) (shown as “RE-EXECUTION 5”), then re-executes the transaction 6 in the thread 2 (342) (shown as “RE-EXECUTION 6”), and then re-executes the transaction 7 in the thread 3 (343) (shown as “RE-EXECUTION 7”), it is optional which thread executes which transaction, and it is not limited to those mentioned above.

FIG. 4A shows example 5 according to the embodiment of the present invention. In the example 5, in response to the occurrence of an abort in one transaction among transactions in multiple threads, all but one or more threads coming later in the order of execution of transactions are barrier synchronized until transactions in all but one or more threads coming later in the order of execution of transactions being processed (being executed or aborted) when the abort is detected are all committed.

FIG. 4A shows that transactions are being executed in thread 1 to thread 3 (411, 412, and 413), respectively. It is assumed that the transactions do not vary in execution time very much from each other (also called uniform transactions).

Since a transaction 5 (thread 2 (412)) having number 5 preceding a transaction 6 has not been completed just before the end of the transaction 6 in the thread 3 (413), the computer 101 determines that it is not the turn of the transaction 6 to be committed. In response to the fact that it is not the turn of the transaction 6 to be committed, the computer 101 aborts the transaction 6. In response to the detection of the abort, the computer 101 sets a barrier synchronization flag for barrier synchronization of all but a thread(s) coming later in the order of execution of transactions being processed (being executed or aborted) when the abort is detected. Then, the computer 101 re-executes the transaction 6 (shown as “RE-EXECUTION 6”). Since the re-execution 6 is completed (i.e., the re-execution 6 is committed) in the thread 3 (413) and the barrier synchronization flag is set, the computer 101 waits without processing the next transaction in the thread 3 (413) until barrier synchronization 421) of all but one or more threads coming later in the order of execution of transactions being processed (being executed or aborted) when the abort is detected is performed. In other words, since the barrier synchronization flag is set, the computer 101 performs barrier synchronization 421) of all threads (thread 1 (411) and thread 3 (413)) but the thread 2 (412) is performed until transactions in all the threads (thread 1 (411) and thread 3 (413)) but the thread 2 (412) (in the process of executing a transaction 8) coming later in the order of execution of transactions (transaction 6, and transaction 7 and transaction 8 mentioned below) being processed (being executed or aborted) when the abort is detected are all committed.

After the abort of the transaction 6 occurs in the thread 3 (413) as mentioned above, the computer 101 detects the occurrence of the abort at a time point (ABORT DETECTION) shown in FIG. 4A.

When the abort in the thread 3 (413) is detected, the computer 101 is executing a transaction 7 in the thread 1 (411). Since the transaction 6 (thread 3 (413)) having number 6 preceding the transaction 7 has not been completed just before the end of the transaction 7, the computer 101 determines that it is not the turn of the transaction 7 to be committed. In response to the fact that it is not the turn of the transaction 7 to be committed, the computer 101 aborts the transaction 7. In response to the detection of the abort, the computer 101 sets the barrier synchronization flag for barrier synchronization of all threads, or considers that it has set the barrier synchronization flag because the barrier synchronization flag is already set, to re-execute the transaction 7 (shown as “RE-EXECUTION 7”). In response to the fact that the re-execution 7 is completed (i.e., that the re-execution 7 is committed), the computer 101 ends the barrier synchronization 421) because the barrier synchronization flag is set and transactions (re-execution 6 and re-execution 7) in all the threads (thread 1 (411) and thread 3 (413)) but the thread 2 (412) are all committed.

When the abort in the thread 3 (413) is detected, the computer 101 is executing a transaction 8 in the thread 2 (412). Since the transaction 7 (thread 1 (411)) having number 7 preceding the transaction 8 has not been completed just before the end of the transaction 8, the computer 101 determines that it is not the turn of the transaction 8 to be committed. In response to the fact that it is not the turn of the transaction 8 to be committed, the computer 101 aborts the transaction 8. Since the thread 2 (412) is not a target thread for the barrier synchronization 421) though the barrier synchronization flag is already set, the computer 101 continuously executes a re-execution 8. Since the re-execution 7 (thread 1 (411)) having number 7 preceding the transaction 8 has been completed just before the end of the transaction 8, the computer 101 determines that it is the turn of the transaction 8 to be committed, and commits the transaction 8.

In response to the completion of the barrier synchronization 421), the computer 101 resumes transaction processing in all the threads (thread 1 (411) and thread 3 (413)) but the thread 2 (412). In other words, the computer 101 repeats processing for detecting an abort and performing barrier synchronization.

Note that, although FIG. 4A shows that the computer 101 executes a transaction 9 in the thread 1 (411), and then executes a transaction 10 in the thread 3 (413), it is optional which thread executes which transaction, and it is not limited to those mentioned above.

In the example 5 mentioned above, the barrier synchronization 421) of all the threads (thread 1 (411) and thread 3 (413)) but the thread 2 (412) is performed until transactions in all the threads (thread 1 (411) and thread 3 (413)) but the thread 2 (412) coming later in the order of execution of transactions being processed (being executed or aborted) when the abort of the transaction 6 in the thread 3 (413) is detected are all committed, thereby preventing a chain of aborts.

FIG. 4B shows example 6 according to the embodiment of the present invention. In the example 6, an abort rate is calculated during the execution of a program with transactions largely varying in execution time from each other, and in response to the occurrence of an abort in one transaction among transactions in multiple threads, all but one or more threads coming later in the order of execution of transactions are barrier synchronized on condition that the above measured abort rate is lower than a predetermined threshold value until transactions in all but one or more threads coming later in the order of execution of transactions being processed (being executed or aborted) when the abort is detected are all committed.

FIG. 4B shows that transactions are being executed in thread 1 to thread 3 (441, 442, and 443), respectively. It is assumed that the transactions largely vary in execution time from each other (also called non-uniform transactions).

Since a transaction 2 (thread 2 (442)) having number 2 preceding a transaction 3 has not been completed just before the end of the transaction 3 in the thread 3 (443), the computer 101 determines that it is not the turn of the transaction 3 to be committed. In response to the fact that it is not the turn of the transaction 3 to be committed, the computer 101 aborts the transaction 3. In response to the detection of the abort of the transaction 3 in the thread 3 (443), the computer 101 sets a barrier synchronization flag for barrier synchronization of all but a thread(s) coming later in the order of execution of transactions being processed (being executed or aborted) when the abort is detected. Then, the computer 101 re-executes the transaction 3 (shown as “RE-EXECUTION 3”). Since the re-execution 3 is completed (i.e., the re-execution 3 is committed) in the thread 3 (443) and the barrier synchronization flag is set, the computer 101 waits without processing the next transaction until barrier synchronization 451 of all but one or more threads coming later in the order of execution of transactions being executed or aborted when the abort in the thread 3 (443) is detected is performed. In other words, since the barrier synchronization flag is set, the computer 101 performs the barrier synchronization 451 of all the threads (thread 1 (441) and thread 3 (443)) but the thread 2 (442) until transactions in all the threads (thread 1 (441) and thread 3 (443)) but the thread 2 (in the process of executing a transaction 5) (442) coming later in the order of execution of transactions (transaction 3, transaction 4, and transaction 5 mentioned below) being processed (being executed or aborted) when the abort is detected are all committed.

After the abort of the transaction 3 occurs in the thread 3 (443), the computer 101 detects the occurrence of the abort at a time point (ABORT DETECTION 1) shown in FIG. 4B.

When the above abort in the thread 3 (443) is detected, the computer 101 is aborting a transaction 4 in the thread 1 (441). This is because the computer 101 determines that it is not the turn of the transaction 4 to be committed due to the fact that the transaction 3 (thread 3 (443)) having number 3 preceding the transaction 4 has not been completed just before the end of the transaction 4, and in response to the fact that it is not the turn of the transaction 4 to be committed, the computer 101 aborts the transaction 4. In response to the detection of the abort, the computer 101 sets the barrier synchronization flag for barrier synchronization of all threads, or considers that it has set the barrier synchronization flag because the barrier synchronization flag is already set, to re-execute the transaction 4 (shown as “RE-EXECUTION 4”). In response to the completion the re-execution 4 (i.e., the re-execution is committed), the computer 101 clears the barrier synchronization flag because the barrier synchronization flag is set and transactions (re-execution 3 and re-execution 4) in all threads (thread 1 (441) and thread 3 (443)) but the thread 2 (442) are all committed, and ends the barrier synchronization 451.

When the abort in the thread 3 (443) is detected, the computer 101 is executing a transaction 5 in the thread 2 (442). Since the transaction 4 (thread 1 (441)) having number 4 preceding the transaction 5 has not been completed just before the end of the transaction 5, the computer 101 determines that it is not the turn of the transaction 5 to be committed. In response to the fact that it is not the turn of the transaction 5 to be committed, the computer 101 aborts the transaction 5. Since the thread 2 (442) is not a target thread for the barrier synchronization 451 though the barrier synchronization flag is already set, the computer 101 continuously executes a re-execution 5. Since a re-execution 4 (thread 1 (441)) having number 4 preceding the transaction 5 has been completed just before the end of the transaction 5, the computer 101 determines that it is the turn of the re-execution 5 to be committed, and commits the re-execution 5.

In the example 6 mentioned above, the barrier synchronization 451 of all threads (thread 1 (441) and thread 3 (443)) but the thread 2 (442) is performed until transactions in all threads (thread 1 (441) and thread 3 (443)) but the thread 2 (442) coming later in the order execution of transactions being processed (being executed or aborted) when the abort of the transaction 3 in the thread 3 (443) is detected are all aborted, thereby preventing a chain of aborts.

The computer 101 can calculate an abort rate, for example, (1) in response to the detection of the abort of the transaction 3 in the thread 3 (443), (2) in response to the completion of the barrier synchronization 451, (3) at predetermined time intervals, or (4) in response to the fact that a predetermined amount of transactions is processed. Those skilled in the art can arbitrarily select the abort rate defined in the description of FIG. 2A.

In response to the fact that the abort rate is lower than the predetermined threshold value, the computer 101 continuously resumes transaction processing in all the threads (thread 1 (441) and thread 3 (443)) but the thread 2 (442). In other words, the computer 101 repeats processing for detecting an abort and performing barrier synchronization. The reason for determining whether the abort rate is lower than the predetermined threshold value is because, when the transactions largely vary in execution time from each other, transaction processing may be made slow by performing the barrier synchronization of all the threads until transactions being processed (being executed or aborted) when the abort is detected are all committed.

Note that, although FIG. 4B shows that the computer 101 executes a transaction 6 in the thread 1 (441) and then executes a transaction 7 in the thread 3 (443), it is optional which thread executes which transaction, and it is not limited to those mentioned above.

Then, since the transaction 6 (thread 1 (441)) having number 6 preceding the transaction 7 has not been completed just before the end of the transaction 7 in the thread 3 (443), the computer 101 determines that it is not the turn of the transaction 7 to be committed. In response to the fact that it is not the turn of the transaction 7 to be committed, the computer 101 aborts the transaction 7. In response to the detection of the abort of the transaction 7 in the thread 3 (443), the computer 101 sets the barrier synchronization flag for barrier synchronization of all but a thread(s) coming later in the order of execution of transactions being processed (being executed or aborted) when the abort is detected. Then, the computer 101 re-executes the transaction 7 (shown as “RE-EXECUTION 7”). Since the re-execution 7 is completed in the thread 3 (443) (i.e., the re-execution 7 is committed) and the barrier synchronization flag is set, the computer 101 waits without processing the next transaction in the thread 3 (443) until barrier synchronization 452 of all but one or more threads coming later in the order of execution of transactions being processed (being executed or aborted) when the abort is detected is performed. In other words, since the barrier synchronization flag is set, the computer 101 performs the barrier synchronization 452 of all threads (thread 2 (442) and thread 3 (443)) but the thread 1 (441) until transactions in all the threads (thread 2 (442) and thread 3 (443)) but the thread 1 (441) (in the process of executing a transaction 9) coming later in the order of execution of transactions (transaction 7, and transaction 8 and transaction 9 mentioned below) being processed (being executed or aborted) when the abort is detected are all committed.

After the abort of the transaction 7 occurs in the thread 3 (443), the computer 101 detects the occurrence of the abort at a time point (ABORT DETECTION 2) shown in FIG. 4B.

When the abort in the thread 3 (443) is detected, the computer 101 is executing a transaction 8 in the thread 2 (442). Since the transaction 7 (thread 3 (443)) having number 7 preceding the transaction 8 has not been completed just before the end of the transaction 8, the computer 101 determines that it is not the turn of the transaction 8 to be committed, and then, in response to the fact that it is not the turn of the transaction 8 to be committed, the computer 101 aborts the transaction 8. In response to the detection of the abort, the computer 101 sets the barrier synchronization flag for barrier synchronization of all threads, or considers that it has set the barrier synchronization flag because the barrier synchronization flag is already set, to re-execute the transaction 8 (shown as “RE-EXECUTION 8”). In response to the completion of the re-execution 8 (i.e., that the re-execution 8 is committed), the computer 101 clears the barrier synchronization flag because the barrier synchronization flag is set and transactions (re-execution 7 and re-execution 8) in all the threads (thread 2 (442) and thread 3 (443)) but the thread 1 (441) are all committed, and ends the barrier synchronization 452.

When the abort in the thread 3 (443) is detected, the computer 101 is executing a transaction 9 in the thread 1 (441). Since the re-execution 8 (thread 2 (442)) having number 8 preceding the transaction 9 has not been completed just before the end of the transaction 9, the computer 101 determines that it is not the turn of the transaction 9 to be committed. In response to the fact that it is not the turn of the transaction 9 to be committed, the computer 101 aborts the transaction 9. Since the thread 1 (441) is not a target thread for the barrier synchronization 452 though the barrier synchronization flag is already set, the computer 101 continuously executes a re-execution 9. Since the re-execution 8 (thread 2 (442)) having number 8 preceding a re-execution 9 has been completed just before the end of the re-execution 9, the computer 101 determines that it is the turn of the re-execution 9 to be committed, and commits the re-execution 9.

In response to the completion of the barrier synchronization 452, the computer 101 resumes transaction processing in all the threads (thread 2 (442) and thread 3 (443)) but the thread 1 (441). In other words, the computer 101 repeats processing for detecting an abort and performing barrier synchronization.

In the example 6 mentioned above, in response to that fact that the abort rate is lower than the predetermined threshold value, the barrier synchronization 452 of all the threads (thread 2 (442) and thread 3 (443)) but the thread 1 (441) is performed until transactions in all the threads (thread 2 (442) and thread 3 (443)) but the thread 1 (441) coming later in the order or execution of transactions being processed (being executed or aborted) when the abort of the transaction 7 in the thread 3 (443) is detected are all aborted, thereby preventing a chain of aborts.

The computer 101 can calculate an abort rate, for example, (1) in response to the detection of the abort of the transaction 7 in the thread 3 (443), (2) in response to the completion of the barrier synchronization 452, (3) at predetermined time intervals, or (4) in response to the fact that a predetermined amount of transactions is processed. Those skilled in the art can arbitrarily select the abort rate defined in the description of FIG. 2B.

In response to the fact that the abort rate is lower than the predetermined threshold value, the computer 101 continuously resumes transaction processing in all the threads (thread 2 (442) and thread 3 (443)) but the thread 1 (441). In other words, the computer 101 repeats processing for detecting an abort and performing barrier synchronization. The reason for determining whether the abort rate is lower than the predetermined threshold value is because, when the transactions largely vary in execution time from each other, transaction processing may be made slow by performing the barrier synchronization of all the threads until transactions in all the threads but a thread(s) coming later in the order of execution of transactions being processed (being executed or aborted) when the abort is detected are all committed.

Note that, although FIG. 4B shows that the computer 101 executes a transaction 10 in the thread 2 (441), and then executes a transaction 11 in the thread 3 (443), it is optional which thread executes which transaction, and it is not limited to those mentioned above.

FIG. 5A shows example 7 according to the embodiment of the present invention. In the example 7, in response to the occurrence of an abort in one transaction among transactions in multiple threads, all but one or more threads coming later in the order of execution of transactions are barrier synchronized until transactions in all but one or more threads coming later in the order of execution of transactions being processed (being executed or aborted) when the abort is detected are all aborted.

FIG. 5A shows that transactions are being executed in thread 1 to thread 3 (511, 512, and 513), respectively. It is assumed that the transactions do not vary in execution time very much from each other (also called uniform transactions).

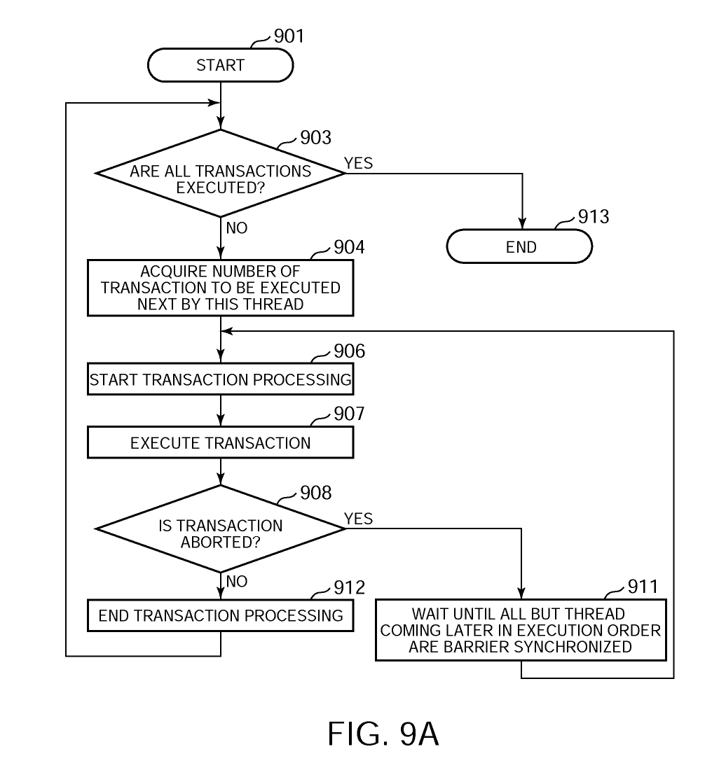

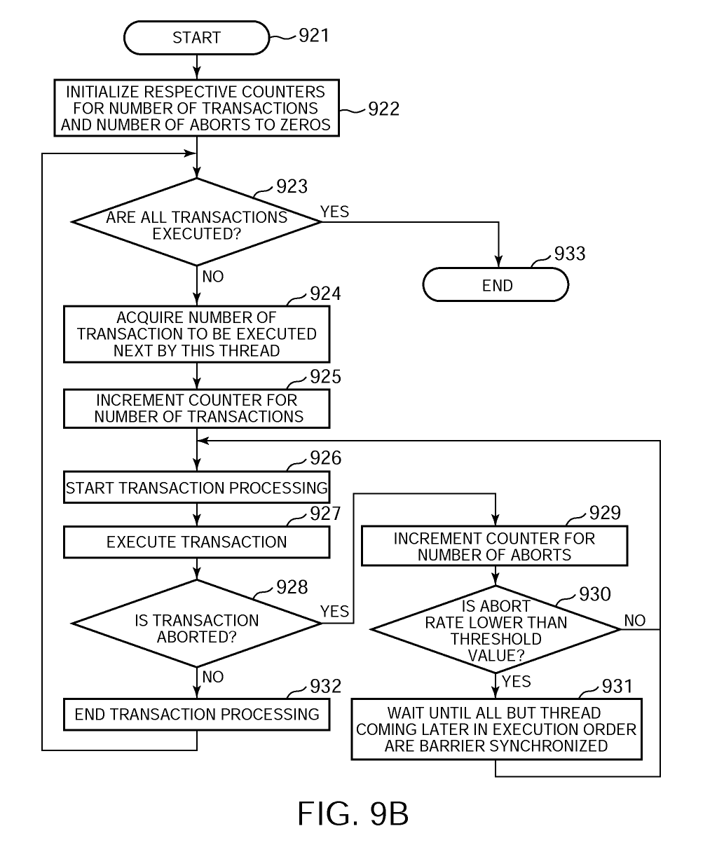

Since a transaction 5 (thread 2 (512)) having number 5 preceding a transaction 6 has not been completed just before the end of the transaction 6 in the thread 3 (513), the computer 101 determines that it is not the turn of the transaction 6 to be committed. In response to the fact that it is not the turn of the transaction 6 to be committed, the computer 101 aborts the transaction 6. In response to the detection of the abort, the computer 101 waits without processing the next transaction in the thread 3 (513) until barrier synchronization 521 of all threads but a thread(s) coming later in the order of execution of transactions being processed (being executed or aborted) when the abort is detected is performed. In other words, the computer 101 performs the barrier synchronization 521 of all the threads (thread 1 (511) and thread 3 (513)) but the thread 2 (512) until transactions in all the threads (thread 1 (511) and thread 3 (513)) but the thread 2 (in the process of executing a transaction 8) (512) coming later in the order of execution of transactions (transaction 6, transaction 7, and transaction 8 mentioned below) being processed (being executed or aborted) when the abort is detected are all aborted. In the example 7, since the step of determining whether to perform the barrier synchronization and the step of actually performing the barrier synchronization are the same (see step 911 in FIG. 9A to be mentioned later), the barrier synchronization flag for barrier synchronization of all threads does not always have to be set.

After the abort of the transaction 6 occurs in the thread 3 (513), the computer 101 detects the occurrence of the abort at a time point (ABORT DETECTION) shown in FIG. 5A.

When the abort of the transaction 6 in the thread 3 (513) is detected, the computer 101 is executing a transaction 7 in the thread 1 (511). Since the transaction 6 (thread 3 (513)) having number 6 preceding the transaction 7 has not been completed (being barrier synchronized) just before the end of the transaction 7, the computer 101 determines that it is not the turn of the transaction 7 to be committed. In response to the fact that it is not the turn of the transaction 7 to be committed, the computer 101 aborts the transaction 7.

In response to the fact that the transaction 7 is aborted, the computer 101 ends the barrier synchronization 521 because transactions (transaction 6 and transaction 7) in all the threads (thread 1 (511) and thread 3 (513)) but the thread 2 (in the process of executing a transaction 8) (512) coming later in the order of execution of transactions (transaction 6, transaction 7, and transaction 8) being processed (being executed or aborted) when the abort of the transaction 6 in the thread 3 (513) is detected are all aborted.

When the abort in the thread 3 (513) is detected, the computer 101 is executing a transaction 8 in the thread 2 (512). Since the transaction 7 (thread 1 (511)) having number 7 preceding the transaction 8 has not been completed just before the end of the transaction 8, the computer 101 determines that it is not the turn of the transaction 8 to be committed. In response to the fact that it is not the turn of the transaction 8 to be committed, the computer 101 aborts the transaction 8. Since the thread 2 (512) is not a target thread for the barrier synchronization 521, the computer 101 continuously executes a re-execution 8. Since the re-execution 7 (thread 3 (513)) having number 7 preceding the re-execution 8 has been completed just before the end of the re-execution 8, the computer 101 determines that it is the turn of the re-execution 8 to be committed, and commits the re-execution 8.

In response to the completion of the barrier synchronization 521, the computer 101 resumes transaction processing in all the threads (thread 1 (511) and thread 3 (513)) but the thread 2 (512). In other words, the computer 101 repeats processing for detecting an abort and performing barrier synchronization.

Note that, although FIG. 5A shows that the computer 101 re-executes the transaction 6 in the thread 1 (511) (shown as “RE-EXECUTION 6”) and then re-executes the transaction 7 in the thread 3 (513) (shown as “RE-EXECUTION 7”), it is optional which thread re-executes which transaction, and it is not limited to those mentioned above.

In the example 7 mentioned above, the barrier synchronization 521 of all the threads (thread 1 (511) and thread 3 (513)) but the thread 2 (512) is performed until transactions in all the threads (thread 1 (511) and thread 3 (513)) but the thread 2 (512) coming later in the order of execution of transactions being processed (being executed or aborted) when the abort of the transaction 6 in the thread 3 (513) is detected are all aborted, thereby preventing a chain of aborts.

FIG. 5B shows example 8 according to the embodiment of the present invention. In the example 8, an abort rate is calculated during the execution of a program with transactions largely varying in execution time from each other, and in response to the occurrence of an abort in one transaction among transactions in multiple threads, all but one or more threads coming later in the order of execution of transactions are barrier synchronized on condition that the above measured abort rate is lower than a predetermined threshold value until transactions in all but one or more threads coming later in the order of execution of transactions being processed (being executed or aborted) when the abort is detected are all aborted.

FIG. 5B shows that transactions are being executed in thread 1 to thread 3 (541, 542, and 543), respectively. It is assumed that the transactions largely vary in execution time from each other (also called non-uniform transactions).

Since a transaction 2 (thread 2 (542)) having number 2 preceding a transaction 3 has not been completed just before the end of the transaction 3 in the thread 3 (543), the computer 101 determines that it is not the turn of the transaction 3 to be committed. In response to the fact that it is not the turn of the transaction 3 to be committed, the computer 101 aborts the transaction 3. In response to the detection of the abort, the computer 101 waits without processing the next transaction in the thread 3 (543) until barrier synchronization 551 of all threads but a thread(s) coming later in the order of execution of transactions being processed (being executed or aborted) when the abort is detected is performed. In other words, the computer 101 performs the barrier synchronization 551 of all the threads (thread 1 (541) and thread 3 (543)) but the thread 2 (542) until transactions in all the threads (thread 1 (541) and thread 3 (543)) but the thread 2 (542) (in the process of executing a transaction 5) coming later in the order of execution of transactions (transaction 3, and transaction 4 and transaction 5 mentioned below) being processed (being executed or aborted) when the abort is detected are all aborted. In the example 8, since the step of determining whether to perform the barrier synchronization and the step of actually performing the barrier synchronization are the same (see step 931 in FIG. 9B to be mentioned later), the barrier synchronization flag for barrier synchronization of all threads does not always have to be set.

After the abort of the transaction 3 occurs in the thread 3 (543), the computer 101 detects the occurrence of the abort at a time point (ABORT DETECTION 1) shown in FIG. 5B.

When the abort of the transaction 3 in the thread 3 (543) is detected, the computer 101 is aborting a transaction 4 in the thread 1 (541). Since the transaction 3 (thread 3 (543)) having number 3 preceding the transaction 4 has not been completed (being aborted) just before the end of the transaction 4, the computer 101 determines that it is not the turn of the transaction 4 to be committed. In response to the fact that it is not the turn of the transaction 4 to be committed, the computer 101 aborts the transaction 4.

In response to the fact that the transaction 4 is aborted in the thread 1 (541), the computer 101 ends the barrier synchronization 551 because transactions (transaction 3 and transaction 4) in all the threads (thread 1 (541) and thread 3 (543)) but the thread 2 (in the process of executing a transaction 5) (542) coming later in the order of execution of transactions (transaction 2, transaction 3, and transaction 4) being processed (being executed or aborted) when the abort of the transaction 3 in the thread 3 (543) is detected are all aborted.

When the abort in the thread 3 (543) is detected, the computer 101 is executing the transaction 5 in the thread 2 (542). Since the transaction 4 (thread 1 (541)) having number 4 preceding the transaction 5 has not been completed just before the end of the transaction 5, the computer 101 determines that it is not the turn of the transaction 5 to be committed. In response to the fact that it is not the turn of the transaction 5 to be committed, the computer 101 aborts the transaction 5. Since the thread 2 (542) is not a target thread for the barrier synchronization 551, the computer 101 continuously re-executes the transaction 5 (shown as “RE-EXECUTION 5”). Since a re-execution 4 (thread 3 (543)) having number 4 preceding the transaction 5 has been completed just before the end of the transaction 5, the computer 101 determines that it is the turn of the re-execution 5 to be committed, and commits the re-execution 5.

In the example 8 mentioned above, the barrier synchronization 551 of all the threads (thread 1 (541) and thread 3 (543)) but the thread 2 (542) is performed until transactions in all the threads (thread 1 (541) and thread 3 (543)) but the thread 2 (542) coming later in the order of execution of transactions being processed (being executed or aborted) when the abort of the transaction 3 in the thread 3 (543) is detected are all aborted, thereby preventing a chain of aborts.

The computer 101 can calculate an abort rate, for example, (1) in response to the detection of the abort of the transaction 3 in the thread 3 (543), (2) in response to the completion of the barrier synchronization 551, (3) at predetermined time intervals, or (4) in response to the fact that a predetermined transaction amount is processed. Those skilled in the art can arbitrarily select the abort rate defined in the description of FIG. 2A.

In response to the fact that the abort rate is lower than the predetermined threshold value, the computer 101 continuously resumes transaction processing in all the threads (thread 1 (541) and thread 3 (543)) but the thread 2 (542). In other words, the computer 101 repeats processing for detecting an abort and performing barrier synchronization. The reason for determining whether the abort rate is lower than the predetermined threshold value is because, when the transactions largely vary in execution time from each other, transaction processing may be made slow by performing the barrier synchronization of all the threads until transactions being processed (being executed or aborted) when the abort is detected are all aborted.

Note that, although FIG. 5B shows that the computer 101 re-executes the transaction 3 in the thread 1 (541) (shown as “RE-EXECUTION 3”), and then re-executes the transaction 4 in the thread 3 (543) (shown as “RE-EXECUTION 4”), it is optional which thread re-executes which transaction, and it is not limited to those mentioned above.

Then, since a transaction 6 (thread 1 (541)) having number 6 preceding a transaction 7 has not been completed just before the end of the transaction 7 in the thread 3 (543), the computer 101 determines that it is not the turn of the transaction 7 to be committed. In response to the fact that it is not the turn of the transaction 7 to be committed, the computer 101 aborts the transaction 7. In response to the detection of the abort, the computer 101 waits without processing the next transaction in the thread 3 (543) until barrier synchronization 552 of all threads but a thread(s) coming later in the order of execution of transactions being processed (being executed or aborted) when the abort is detected is performed. In other words, the computer 101 performs the barrier synchronization 552 of all the threads (thread 2 (542) and thread 3 (543)) but the thread 1 (541) until all the threads (thread 2 (542) and thread 3 (543)) but the thread 1 (in the process of executing a transaction 9) (541) coming later in the order of execution of transactions (transaction 7, and transaction 8 and transaction 9 mentioned below) being processed (being executed or aborted) when the abort is detected are all aborted.

After the abort of the transaction 7 occurs in the thread 3 (543), the computer 101 detects the occurrence of the abort at a time point (ABORT DETECTION 2) shown in FIG. 5B.

When the abort of the transaction 7 in the thread 3 (543) is detected, the computer 101 is aborting a transaction 8 in the thread 2 (542).

In response to the completion of the abort of the transaction 8 in the thread 2 (542), the computer 101 ends the barrier synchronization 552 because transactions (transaction 7 and transaction 8) in all the threads (thread 2 (542) and thread 3 (543)) but the thread 1 (in the process of executing the transaction 9) (541) coming later in the order of execution of transactions (transaction 7, transaction 8, and transaction 9) being processed (being executed or aborted) when the abort of the transaction 7 in the thread 3 (543) is detected are all aborted.

When the abort in the thread 3 (543) is detected, the computer 101 is executing the transaction 9 in the thread 1 (541). Since the transaction 8 (thread 3 (543)) having number 8 preceding the transaction 9 has not been completed just before the end of the transaction 9, the computer 101 determines that it is not the turn of the transaction 9 to be committed. In response to the fact that it is not the turn of the transaction 9 to be committed, the computer 101 aborts the transaction 9. Since the thread 1 (541) is not a target thread for the barrier synchronization 552, the computer 101 continuously re-executes the transaction 9 (shown as “RE-EXECUTION 9”). Since a re-execution 8 (thread 3 (543)) having number 8 preceding the re-execution 9 has been completed just before the end of the re-execution 9, the computer 101 determines that it is the turn of the re-execution 9 to be committed, and commits the re-execution 9.

In the example 8 mentioned above, the barrier synchronization 552 of all the threads (thread 2 (542) and thread 3 (543)) but the thread 1 (541) is performed until transactions in all the threads (thread 2 (542) and thread 3 (543)) but the thread 1 (541) coming later in the order of execution of transactions being processed (being executed or aborted) when the abort of the transaction 7 in the thread 3 (543) is detected are all aborted, thereby preventing a chain of aborts.

The computer 101 can calculate an abort rate, for example, (1) in response to the detection of the abort of the transaction 7 in the thread 3 (543), (2) in response to the completion of the barrier synchronization 552, (3) at predetermined time intervals, or (4) in response to the fact that a predetermined transaction amount is processed. Those skilled in the art can arbitrarily select the abort rate defined in the description of FIG. 2B.

In response to the fact that the abort rate is lower than the predetermined threshold value, the computer 101 continuously resumes transaction processing in all the threads (thread 2 (542) and thread 3 (543)) but the thread 1 (541). In other words, the computer 101 repeats processing for detecting an abort and performing barrier synchronization. The reason for determining whether the abort rate is lower than the predetermined threshold value is because, when the transactions largely vary in execution time from each other, transaction processing may be made slow by performing the barrier synchronization of all the threads until transactions in all threads but a thread(s) coming later in the order of execution of transactions being processed (being executed or aborted) when the abort is detected are all aborted.

Note that, although FIG. 5B shows that the computer 101 re-executes the transaction 7 in the thread 2 (542) (shown as “RE-EXECUTION 7”), and then re-executes the transaction 8 in the thread 3 (543) (shown as “RE-EXECUTION 8”), it is optional which thread re-executes which transaction, and it is not limited to those mentioned above.

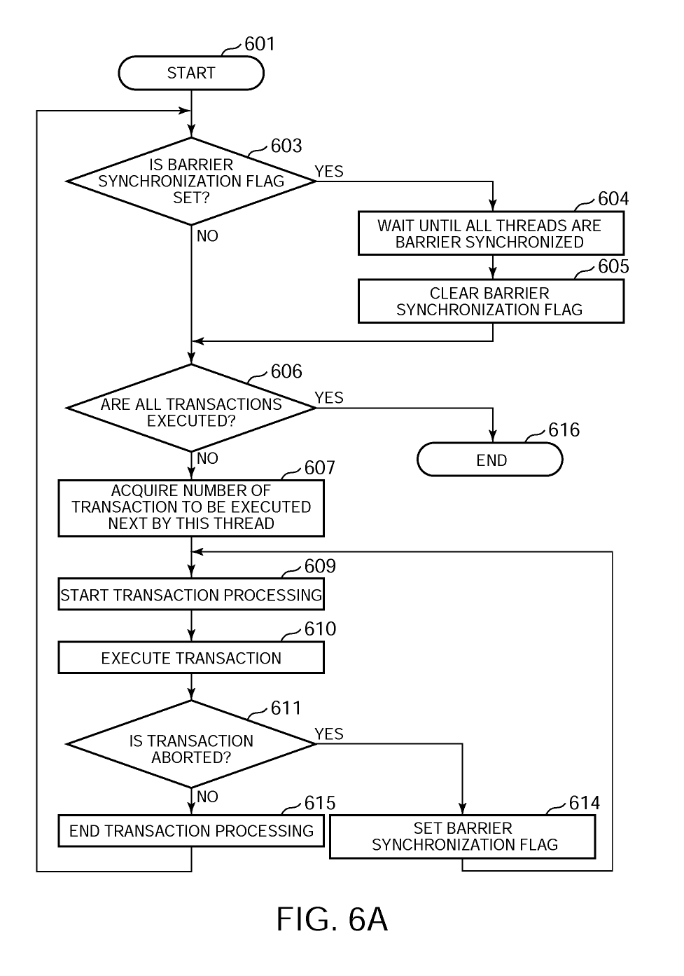

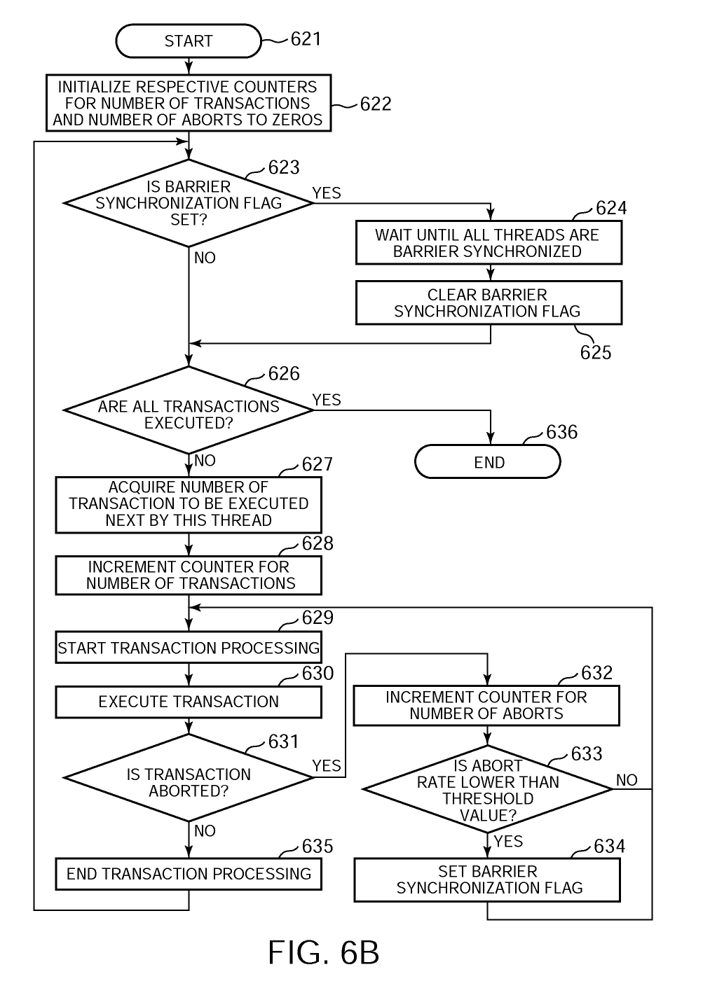

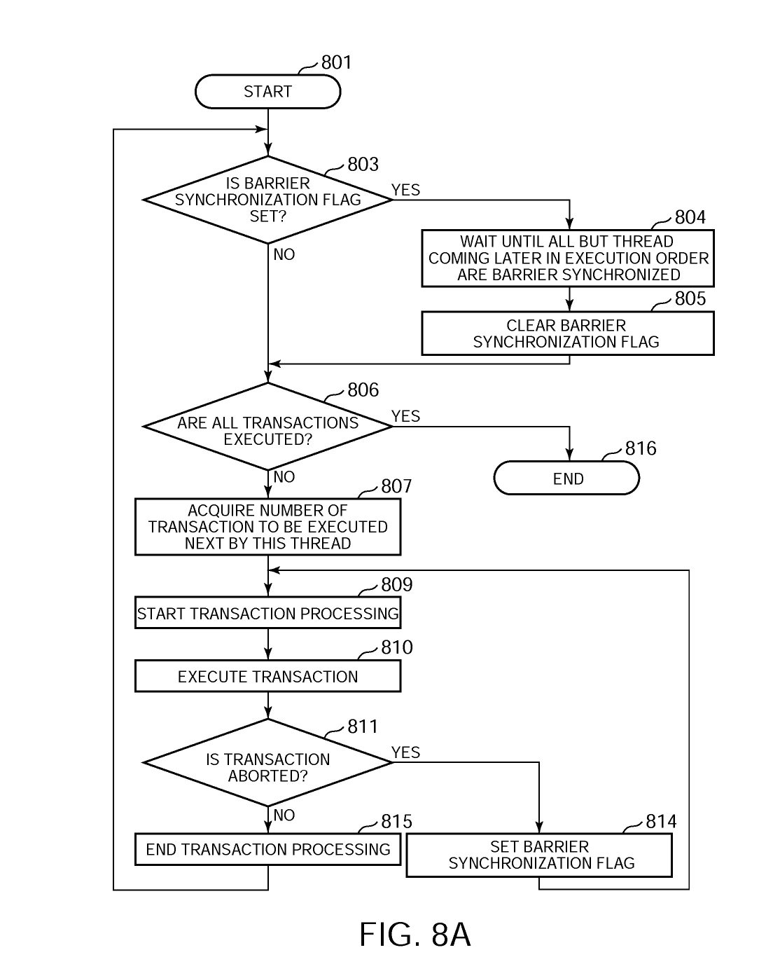

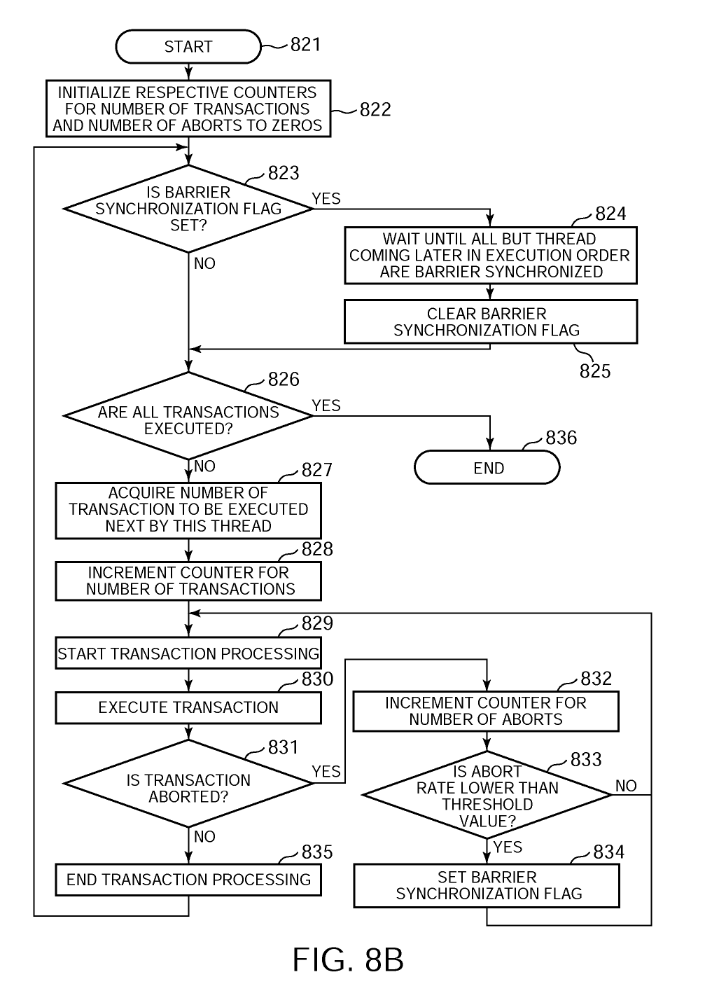

FIG. 6A and FIG. 6B, FIG. 7A and FIG. 7B, FIG. 8A and FIG. 8B, and FIG. 9A and FIG. 9B mentioned below show flowcharts for implementing embodiments shown in the examples 1 and 2 (FIG. 2A and FIG. 2B), the examples 3 and 4 (FIG. 3A and FIG. 3B), the examples 5 and 6 (FIG. 4A and FIG. 4B), and the examples 7 and 8 (FIG. 5A and FIG. 5B), respectively.

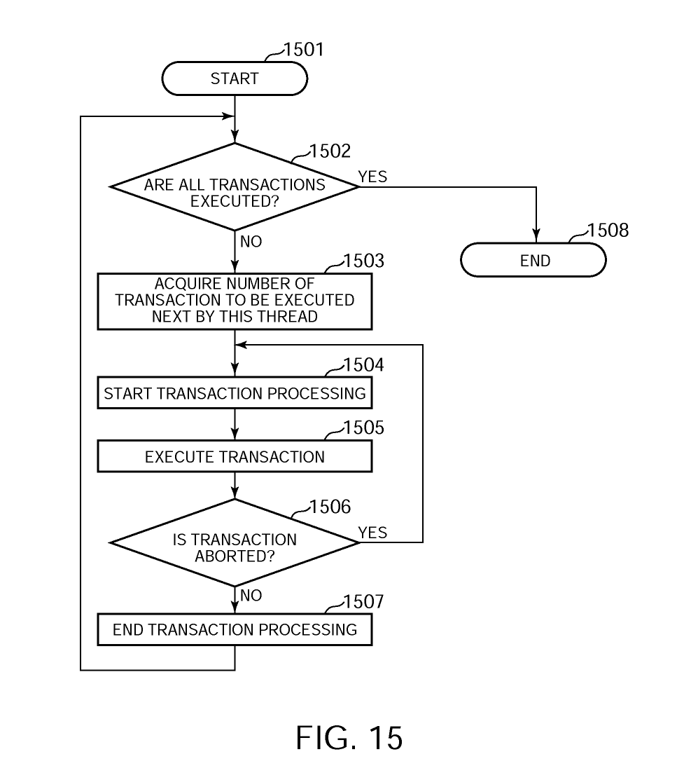

FIG. 6A shows a flowchart for implementing an embodiment shown in the example 1 according to the embodiment of the present invention. The computer 101 executes each of the following processing steps 601 to 616 in each thread (one specific thread is called a “target thread” below) of multiple threads. Steps 606, 607, 609, 610, 611, and 615 correspond to steps 1502, 1503, 1504, 1505, 1506, and 1507 shown in FIG. 15, respectively. Therefore, steps 603 to 605 and step 614 are steps added to the processing of the method with simple implementation as the conventional technique in order to implement the embodiment shown in the example 1.

In step 601, the computer 101 starts, in the target thread, a method for implementing the embodiment shown in the example 1.

In step 603, the computer 101 determines whether a barrier synchronization flag for barrier synchronization of all threads is set. One barrier synchronization flag is provided in common for all threads. In response to the fact that the barrier synchronization flag is set, the computer 101 advances the processing to step 604. On the other hand, in response to the fact that the barrier synchronization flag is not set, the computer 101 advances the processing to step 606.

In step 604, in response to the fact that the barrier synchronization flag is set, the computer 101 performs barrier synchronization of all threads until transactions being processed (being executed or aborted) when an abort is detected are all committed. In other words, the computer 101 does not process the next transaction until the transactions being processed (being executed or aborted) when the abort is detected are all committed (i.e., the computer 101 waits until all the threads are barrier synchronized). In response to the fact that all the threads are barrier synchronized, the computer 101 advances the processing to step 605.

In step 605, in response to the fact that all the threads are barrier synchronized, the computer 101 clears the barrier synchronization flag. Then, the computer 101 advances the processing to step 606.

In step 606, the computer 101 determines whether all transactions are executed. In response to the fact that all the transactions are not executed, the computer 101 advances the processing to step 607 to execute the remaining transactions. On the other hand, in response to the fact that all the transactions are executed, the computer 101 advances the processing to the end step 616.

In step 607, the computer 101 acquires the number of a transaction to be executed next by the target thread.

In step 609, the computer 101 starts processing the transaction of the acquired number in the target thread.

In step 610, the computer 101 executes the transaction of the acquired number in the target thread.

In step 611, the computer 101 determines whether the transaction is aborted in the target thread. In response to the fact that the transaction is aborted, the computer 101 advances the processing to step 614. On the other hand, in response to the fact that the transaction is not aborted, the computer 101 advances the processing to step 615.

In step 614, in response to the fact that the transaction is aborted, the computer 101 sets the barrier synchronization flag. When the barrier synchronization flag is already set, the computer 101 considers that it has set the barrier synchronization flag. Then, the computer 101 returns the processing to step 609 to re-execute the aborted transaction.

In step 615, in response to the fact that the transaction is not aborted, the computer 101 ends the transaction processing in the target thread (i.e., the computer 101 commits the transaction). In response to the end of the transaction processing, the computer 101 returns the processing to step 603.

In step 616, in response to the fact that the execution of all the transactions is completed, the computer 101 ends the method for implementing the embodiment in the target thread shown in the example 1.

FIG. 6B shows a flowchart for implementing an embodiment shown in the example 2 according to the embodiment of the present invention. The computer 101 executes each of the following processing steps 621 to 636 in each thread (target thread) of multiple threads. Steps 626, 627, 629, 630, 631, and 635 correspond to steps 1502, 1503, 1504, 1505, 1506, and 1507 shown in FIG. 15, respectively. Therefore, steps 622 to 625, 628, and 632 to 634 are steps added to the processing of the method with simple implementation as the conventional technique in order to implement the embodiment shown in the example 2. Further, steps 623 to 627, 629 to 631, and 634 and 635 correspond to steps 603 to 607, 609 to 611, and 614 and 615 shown in FIG. 2A, respectively. Therefore, steps 622, 628, and 632 and 633 are steps added to the embodiment shown in the example 1 in order to implement the embodiment shown in the example 2.

In step 621, the computer 101 starts, in the target thread, a method for implementing the embodiment shown in the example 2.

In step 622, the computer 101 initializes a counter for measuring the number of transactions used in common for all threads (hereinafter called the “counter for the number of transactions”) and a counter for measuring the number of aborts (hereinafter called the “counter for the number of aborts”) to zeros.

In step 623, the computer 101 determines whether a barrier synchronization flag for barrier synchronization of all threads is set. One barrier synchronization flag is provided for all the threads. In response to the fact that the barrier synchronization flag is set, the computer 101 advances the processing to step 624. On the other hand, in response to the fact that the barrier synchronization flag is not set, the computer 101 advances the processing to step 626.

In step 624, in response to the fact that the barrier synchronization flag is set, the computer 101 performs barrier synchronization of all threads until transactions being processed (being executed or aborted) when an abort is detected are all committed. In other words, the computer 101 does not process the next transaction until the transactions being processed (being executed or aborted) when the abort is detected are all committed (i.e., the computer 101 waits until all the threads are barrier synchronized). In response to the fact that all the threads are barrier synchronized, the computer 101 advances the processing to step 625.

In step 625, in response to the fact that all the threads are barrier synchronized, the computer 101 clears the barrier synchronization flag. Then, the computer 101 advances the processing to step 626.

In step 626, the computer 101 determines whether all transactions are executed. In response to the fact that all the transactions are not executed, the computer 101 advances the processing to step 627 in order to execute the remaining transactions. On the other hand, in response to the fact that all the transactions are executed, the computer 101 advances the processing to the end step 636.

In step 627, the computer 101 acquires the number of a transaction to be executed next by the target thread.

In step 628, in response to the fact that the number of the transaction to be executed next is acquired, the computer 101 increments the counter for the number of transactions by one.

In step 629, the computer 101 starts processing the transaction of the acquired number in the target thread.

In step 630, the computer 101 executes the transaction of the acquired number in the target thread.

In step 631, the computer 101 determines whether the transaction is aborted in the target thread. In response to the fact that the transaction is aborted, the computer 101 advances the processing to step 632. On the other hand, in response to the fact that the transaction is not aborted, the computer 101 advances the processing to step 635.

In step 632, in response to the fact that the transaction is aborted, the computer 101 increments the counter for the number of aborts by one.

In step 633, the computer 101 determines whether an abort rate is lower than a predetermined threshold value. The threshold value can be, for example, a value experimentally obtained by comparing the embodiment according to the example 2 and the method with simple implementation as the conventional technique in terms of the throughput improvement. In response to the fact that the abort rate is lower than the predetermined threshold value, the computer 101 advances the processing to step 634. On the other hand, in response to the fact that the abort rate is higher than or equal to the predetermined threshold value, the computer 101 returns the processing to step 629.

In step 634, in response to the fact that the abort rate is lower than the predetermined threshold value, the computer 101 sets the barrier synchronization flag. Even when the barrier synchronization flag is already set, the computer 101 performs processing for setting the barrier synchronization flag again. Then, the computer 101 returns the processing to step 629 in order to re-execute the aborted transaction.

In step 635, in response to the fact that the transaction is not aborted, the computer 101 ends the transaction processing in the target thread (i.e., the computer 101 commits the transaction). In response to the completion of the transaction processing, the computer 101 returns the processing to step 623.

In step 636, in response to the fact that the execution of all the transactions is completed, the computer 101 ends the method for implementing the embodiment in the target thread shown in the example 2.

FIG. 7A shows a flowchart for implementing an embodiment shown in the example 3 according to the embodiment of the present invention. The computer 101 executes each of the following processing steps 701 to 713 in each thread (target thread) of multiple threads. Steps 703, 704, 706, 707, 708, and 712 correspond to steps 1502, 1503, 1504, 1505, 1506, and 1507 shown in FIG. 15, respectively. Therefore, step 711 is a step added to the method with simple implementation as the conventional technique in order to implement the embodiment shown in the example 3.

In step 701, the computer 101 starts, in the target thread, a method for implementing the embodiment shown in the example 3.

In step 703, the computer 101 determines whether all transactions are executed. In response to the fact that all the transactions are not executed, the computer 101 advances the processing to step 704 in order to execute the remaining transactions. On the other hand, in response to the fact that all the transactions are executed, the computer 101 advances the processing to the end step 713.

In step 704, the computer 101 acquires the number of a transaction to be executed next by the target thread.

In step 706, the computer 101 starts processing the transaction of the acquired number in the target thread.

In step 707, the computer 101 executes the transaction of the acquired number in the target thread.

In step 708, the computer 101 determines whether the transaction is aborted in the target thread. In response to the fact that the transaction is aborted, the computer 101 advances the processing to step 711. On the other hand, in response to the fact that the transaction is not aborted, the computer 101 advances the processing to step 712.

In step 711, in response to the fact that the transaction is aborted, the computer 101 performs barrier synchronization of all threads until transactions being processed (being executed or aborted) when the abort is detected are all aborted. In other words, the computer 101 does not process the next transaction until the transactions being processed (being executed or aborted) when the abort is detected are all aborted (i.e., the computer 101 waits until all the threads are barrier synchronized). In response to the fact that all the threads are barrier synchronized, the computer 101 returns the processing to step 706.

In step 712, in response to the fact that the transaction is not aborted, the computer 101 ends the transaction processing in the target thread (i.e., the computer 101 commits the transaction). In response to the end of the transaction processing, the computer 101 returns the processing to step 703.

In step 713, in response to the fact that the execution of all the transactions is completed, the computer 101 ends the method for implementing the embodiment in the target thread shown in the example 3.

FIG. 7B shows a flowchart for implementing an embodiment shown in the example 4 according to the embodiment of the present invention. The computer 101 executes each of the following processing steps 721 to 733 in each thread (target thread) of multiple threads. Steps 723, 724, 726, 727, 728, and 732 correspond to steps 1502, 1503, 1504, 1505, 1506, and 1507 shown in FIG. 15, respectively. Therefore, steps 722, 725, and 729 to 731 are steps added to the method with simple implementation as the conventional technique in order to implement the embodiment shown in the example 4. Further, steps 723 and 724, 726 to 728, and 731 and 732 correspond to steps 703 and 704, 706 to 708, and 711 and 712 shown in FIG. 3A, respectively. Therefore, steps 722, 725, and 729 and 730 are steps added to the embodiment shown in the example 3 in order to implement the embodiment shown in the example 4.

In step 721, the computer 101 starts, in the target thread, a method for implementing the embodiment shown in the example 4.

In step 722, the computer 101 initializes the counter for measuring the number of transactions used in common for all threads (the counter for the number of transactions) and the counter for measuring the number of aborts (the counter for the number of aborts) to zeros.

In step 723, the computer 101 determines whether all transactions are executed. In response to the fact that all the transactions are not executed, the computer 101 advances the processing to step 724 in order to execute the remaining transactions. On the other hand, in response to the fact that all the transactions are executed, the computer 101 advances the processing to the end step 733.

In step 724, the computer 101 acquires the number of a transaction to be executed next by the target thread.

In step 725, in response to the fact that the number of the transaction to be executed next is acquired, the computer 101 increments the counter for the number of transactions by one.

In step 726, the computer 101 starts processing the transaction of the acquired number in the target thread.

In step 727, the computer 101 executes the transaction of the acquired number in the target thread.

In step 728, the computer 101 determines whether the transaction is aborted in the target thread. In response to the fact that the transaction is aborted, the computer 101 advances the processing to step 729. On the other hand, in response to the fact that the transaction is not aborted, the computer 101 advances the processing to step 732.

In step 729, in response to the fact that the transaction is aborted, the computer 101 increments the counter for the number of aborts by one.

In step 730, the computer 101 determines whether an abort rate is lower than a predetermined threshold value. The threshold value can be, for example, a value experimentally obtained by comparing the embodiment according to the example 4 and the method with simple implementation as the conventional technique in terms of the throughput improvement. In response to the fact that the abort rate is lower than the predetermined threshold value, the computer 101 advances the processing to step 731. On the other hand, in response to the fact that the abort rate is higher than or equal to the predetermined threshold value, the computer 101 returns the processing to step 726.

In step 731, in response to the fact that the abort rate is lower than the predetermined threshold value, the computer 101 performs barrier synchronization of all threads until transactions being processed (being executed or aborted) when the abort is detected are all aborted. In other words, the computer 101 does not process the next transaction until the transactions being processed (being executed or aborted) when the abort is detected are all aborted (i.e., the computer 101 waits until all the threads are barrier synchronized). In response to the fact that all the threads are barrier synchronized, the computer 101 returns the processing to step 726.

In step 732, in response to the fact that the transaction is not aborted, the computer 101 ends the transaction processing in the target thread (i.e., the computer 101 commits the transaction). In response to the end of the transaction processing, the computer 101 returns the processing to step 723.

In step 733, in response to the fact that the execution of all the transactions is completed, the computer 101 ends the method for implementing the embodiment in the target thread shown in the example 4.

FIG. 8A shows a flowchart for implementing an embodiment shown in the example 5 according to the embodiment of the present invention. The computer 101 executes each of the following processing steps 801 to 816 in each thread (target thread) of multiple threads. Steps 801 and 803, and 806 to 816 correspond to steps 601 and 603, and 606 to 616 shown in FIG. 6A, respectively. Therefore, see the description of steps 601 and 603, and 606 to 616 for steps 801 and 803m and 806 to 816, respectively. The following will describe step 804 and step 805.

In step 804, in response to the fact that the barrier synchronization flag is set, the computer 101 performs barrier synchronization of all threads but a thread coming later in the order of execution of transactions being processed (being executed or aborted) when the abort is detected until the transactions in all the threads but the thread coming later in the order of execution of the transactions are all committed. In other words, the computer 101 does not process the next transaction in all the threads but the thread coming later in the order of execution of transactions being processed (being executed or aborted) when the abort is detected until the transactions in all the threads but the thread coming later in the order of execution of the transactions are all committed (i.e., the computer 101 waits until all the threads but the thread coming later in the order of execution of the transactions are barrier synchronized). In response to the fact that all the threads but the thread coming later in the order of execution of the transactions are barrier synchronized, the computer 101 advances the processing to step 805.

In step 805, in response to the fact that all the threads but the thread coming later in the order of execution of the transactions are barrier synchronized, the computer 101 clears the barrier synchronization flag. Then, the computer 101 advances the processing to step 806.

FIG. 8B shows a flowchart for implementing an embodiment shown in the example 6 according to the embodiment of the present invention. The computer 101 executes each of the following processing steps 821 to 836 in each thread (target thread) of multiple threads. Steps 821 to 823 and 826 to 836 correspond to step 621 to 623 and 626 to 636 shown in FIG. 6B, respectively. Therefore, see the description of steps 621 to 623 and 626 to 636 for steps 821 to 823 and 826 to 836, respectively. The following will describe step 824 and step 825.

In step 824, in response to the fact that the barrier synchronization flag is set, the computer 101 performs barrier synchronization of all threads but a thread coming later in the order of execution of transactions being processed (being executed or aborted) when the abort is detected until the transactions in all the threads but the thread coming later in the order of execution of the transactions are all committed. In other words, the computer 101 does not process the next transaction in all the threads but the thread coming later in the order of execution of the transactions being processed (being executed or aborted) when the abort is detected until the transactions in all the threads but the thread coming later in the order of execution of the transactions are all committed (i.e., the computer 101 waits until all the threads but the thread coming later in the order of execution of the transactions are barrier synchronized). In response to the fact that all the threads but the thread coming later in the order of execution of the transactions are barrier synchronized, the computer 101 advances the processing to step 825.

In step 825, in response to the fact that all the threads but the thread coming later in the order of execution of the transactions are barrier synchronized, the computer 101 clears the barrier synchronization flag. Then, the computer 101 advances the processing to step 826.

FIG. 9A shows a flowchart for implementing an embodiment shown in the example 7 according to the embodiment of the present invention. The computer 101 executes each of the following processing steps 901 to 913 in each thread (target thread) of multiple threads. Steps 901 to 908, and 912 and 913 correspond to steps 701 to 708, and 712 and 713, respectively. Therefore, see the description of steps 701 to 708, and 712 and 713 for steps 901 to 908, and 912 and 913, respectively. The following will describe step 911.

In step 911, in response to the fact that the transaction is aborted, the computer 101 performs barrier synchronization of all threads but a thread coming later in the order of execution of transactions being processed (being executed or aborted) when the abort is detected until the transactions in all the threads but the thread coming later in the order of execution of the transactions are all aborted. In other words, the computer 101 does not process the next transaction in all the threads but the thread coming later in the order of execution of the transactions being processed (being executed or aborted) when the abort is detected until the transactions in all the threads but the thread coming later in the order of execution of the transactions are all aborted (i.e., the computer 101 waits until all the threads but the thread coming later in the order of execution of the transactions are barrier synchronized). In response to the fact that all the threads but the thread coming later in the order of execution of the transactions are barrier synchronized, the computer 101 returns the processing to step 906.

FIG. 9B shows a flowchart for implementing an embodiment shown in the example 8 according to the embodiment of the present invention. The computer 101 executes each of the following processing steps 921 to 933 in each thread (target thread) of multiple threads. Steps 921 to 930, and 932 and 933 correspond to steps 721 to 730, and 732 and 733 shown in FIG. 7B, respectively. Therefore, see the description of steps 721 to 730, and 732 and 733 for steps 921 to 930, and 932 and 933, respectively. The following will describe step 931.

In step 931, in response to the fact that the abort rate is lower than the predetermined threshold value, the computer 101 performs barrier synchronization of all threads but a thread coming later in the order of execution of transactions being processed (being executed or aborted) when the abort is detected until the transactions in all the threads but the thread coming later in the order of execution of the transactions are all aborted. In other words, the computer 101 does not process the next transaction in all the threads but the thread coming later in the order of execution of the transactions being processed (being executed or aborted) when the abort is detected until the transactions in all the threads but the thread coming later in the order of execution of the transactions are all aborted (i.e., the computer 101 waits until all the threads but the thread coming later in the order of execution of the transactions are barrier synchronized). In response to the fact that all the threads but the thread coming later in the order of execution of the transactions are barrier synchronized, the computer 101 returns the processing to step 926.

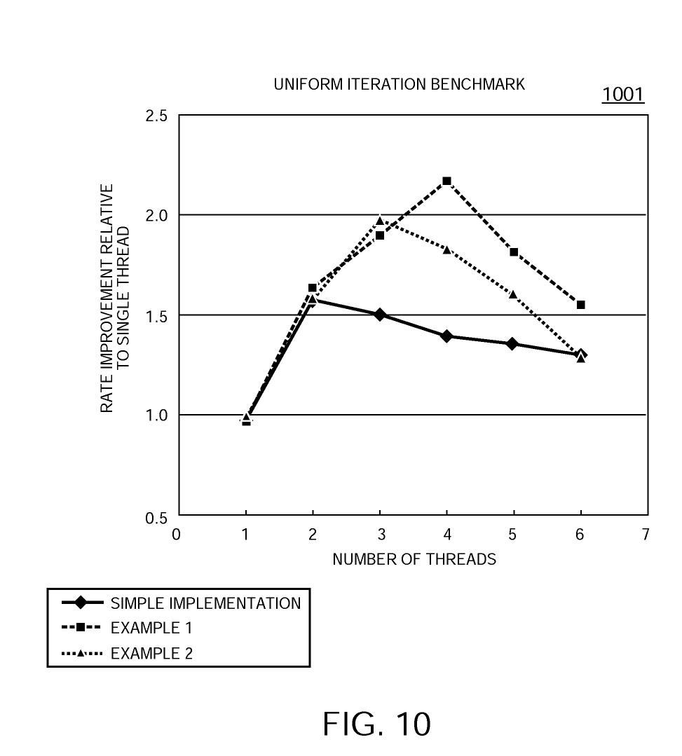

FIG. 10 shows benchmark results in the example 1 and the example 2 according to the embodiment of the present invention.

As a benchmark program, a substantially perfectly parallel program was created, in which a single loop is iterated in all threads a total of 20,000,000 times, and each transaction in the loop adds a local variable specified number of times. In the uniform iteration benchmark, each transaction adds the local variable 1,000 times.

As an implementation to the program, (1) the method with simple implementation as the conventional technique, (2) the method according to the example 1, and (3) the method according to the example 2 were used. In the method according to the example 2, the abort rate was measured while using the method according to the example 1, and when the measured abort rate was greater than or equal to 40 percent, the method was switched to the simple implementation as the conventional technique not to perform barrier synchronization.

As an program experiment environment, the program was executed on the IBM® 16-core 5.5-GHz zEC12.

Graph 1001 shows the uniform iteration benchmark results.

In the method according to the example 1, the performance was 38 percent improved than the method with simple implementation. Further, in the method according to the example 1, the maximum performance was 2.17 times to 1.57 times in the single-threaded ratio.

In the method according to the example 2, the performance was 25 percent improved than the method with simple implementation. Further, in the method according to the example 2, the maximum performance was 1.97 times to 1.57 times in the single-threaded ratio.

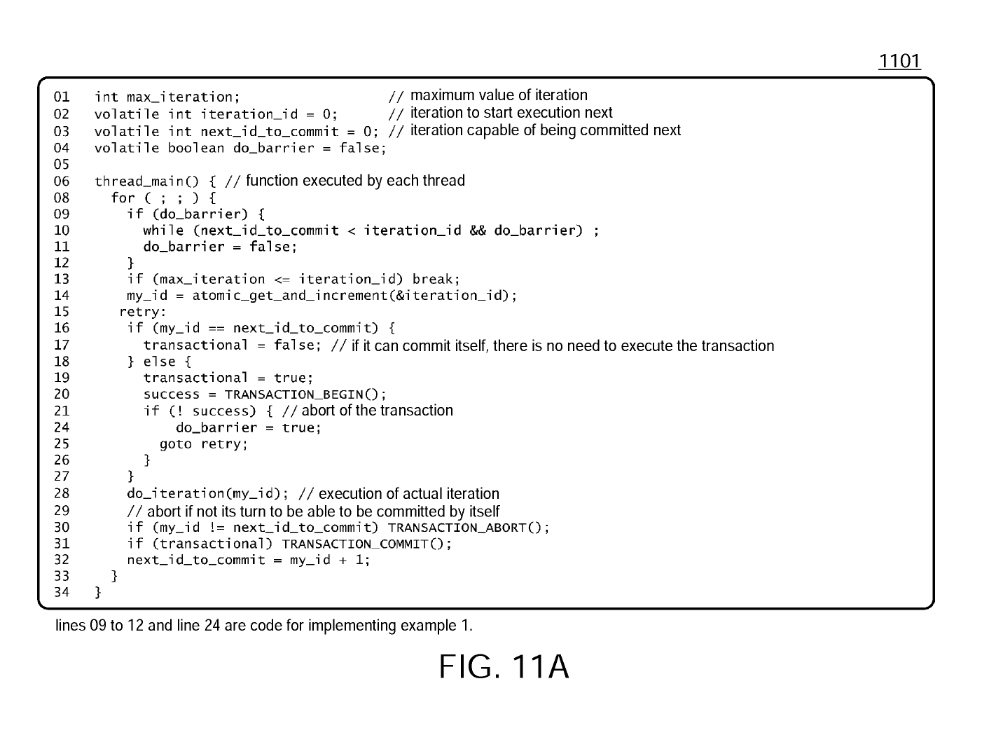

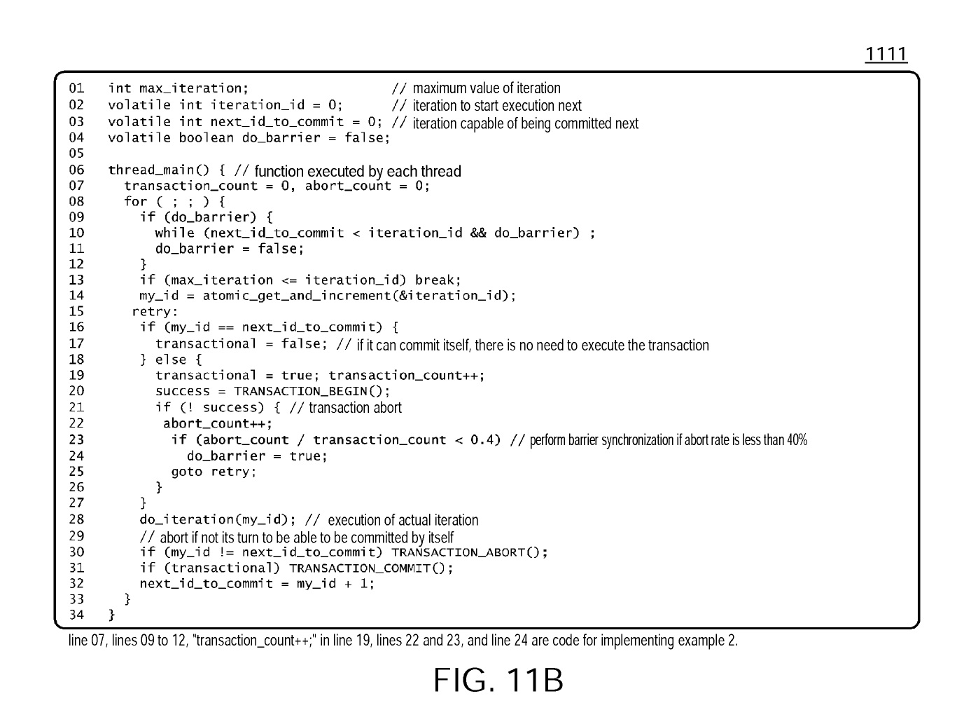

FIG. 11A and FIG. 11B show examples of algorithms for implementing the embodiment of the present invention, respectively.

FIG. 11A shows an algorithm 1101 for implementing the example 1 according to the embodiment of the present invention.

In the algorithm 1101, lines 09 to 12 and line 24 are code inserted to implement the example 1. In the algorithm 1101, numbers (line numbers) 01 to 34 are inserted for ease of description, and they are unnecessary in actual code.

FIG. 11B shows an algorithm 1111 for implementing the example 2 according to the embodiment of the present invention.

In the algorithm 1111, line 07, lines 09 to 12, “transaction_count++;” in line 19, lines 22 and 23, and line 24 are code inserted to implement the example 2. In the algorithm 1111, numbers (line numbers) 01 to 34 are inserted for ease of description, and they are unnecessary in actual code.

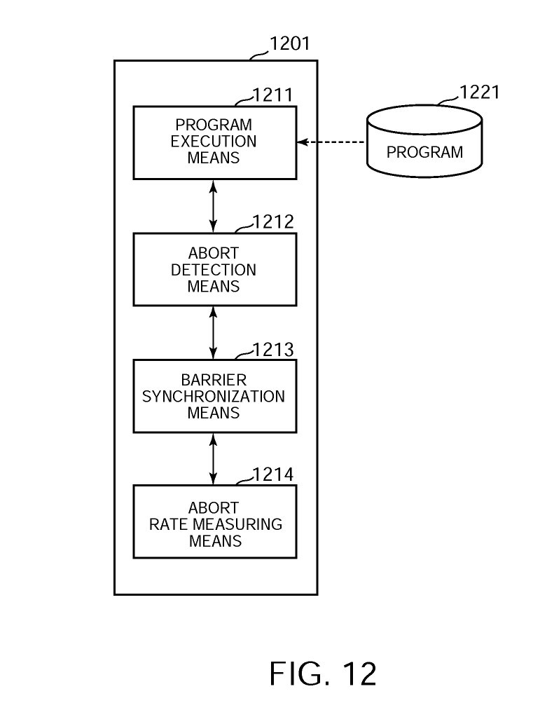

FIG. 12 is a functional block diagram showing an example of a computer 1201 preferably having a hardware configuration according to FIG. 1 to execute ordered transactions in multiple threads according to the embodiment of the present invention.

The computer 1201 is a computer for executing ordered transactions in multiple threads according to the embodiment of the present invention, which is, for example, the computer 101 shown in FIG. 1.

The computer 1201 includes program execution means 1211, abort detection means 1212, barrier synchronization means 1213, and abort rate measuring means 1214.

For example, the program execution means 1211 reads a program for ordered transactions in multiple threads from a storage medium 1221 storing the program, and executes the read program.

The program execution means 1211 can execute steps 606 to 610 and 615 shown in FIG. 6A, steps 626 to 630 and 635 shown in FIG. 6B, steps 703 to 707 and 712 shown in FIG. 7A, steps 723 to 727 and 732 shown in FIG. 7B, steps 806 to 810 and 815 shown in FIG. 8A, steps 826 to 830 and 835 shown in FIG. 8B, steps 903 to 907 and 912 shown in FIG. 9A, and steps 923 to 927 and 932 shown in FIG. 9B.

The abort detection means 1212 detects the occurrence of an abort of at least one of respective transactions in multiple threads.

The abort detection means 1212 can execute step 611 shown in FIG. 6A, steps 631 and 632 shown in FIG. 6B, step 708 shown in FIG. 7A, steps 728 and 729 shown in FIG. 7B, step 811 shown in FIG. 8A, steps 831 and 832 shown in FIG. 8B, step 908 shown in FIG. 9A, and steps 928 and 929 shown in FIG. 9B.

The barrier synchronization means 1213 performs barrier synchronization of at least two threads including a thread in which an abort is detected.

The barrier synchronization means 1213 also performs barrier synchronization of all threads until transactions being processed (being executed or aborted) when the abort is detected are all committed or aborted.

Further, the barrier synchronization means 1213 performs barrier synchronization of all threads until transactions in all threads but one or more threads coming later in the order of execution of transactions being processed (being executed or aborted) when the abort is detected are all committed or aborted.

The barrier synchronization means 1213 can execute steps 603 to 605 and 614 shown in FIG. 6A, steps 623 to 625 and 634 shown in FIG. 6B, step 711 shown in FIG. 7A, step 731 shown in FIG. 7B, steps 803 to 805 and 814 shown in FIG. 8A, steps 823 to 825 and 834 shown in FIG. 8B, step 911 shown in FIG. 9A, and step 931 shown in FIG. 9B.

The abort rate measuring means 1214 measures the abort rate, for example, (1) in response to the detection of an abort, (2) in response to the completion of barrier synchronization, (3) at predetermined time intervals, or (4) in response to the fact that a predetermined transaction amount is processed.

The abort rate measuring means 1214 can execute step 633 shown in FIG. 6B, step 730 shown in FIG. 7B, step 833 shown in FIG. 8B, and step 930 shown in FIG. 9B.

What is claimed is:

1. A method of executing ordered transactions in a plurality of threads, comprising:
running a plurality of threads;
detecting that an abort has occurred in a first transaction in a first thread of the plurality of threads; and
performing barrier synchronization of at least two threads including the first thread.

2. The method according to claim 1, wherein the performance of barrier synchronization includes:
performing barrier synchronization of all threads of the plurality of threads until transactions being processed when the abort is detected are all committed.

3. The method according to claim 1, wherein the performance of barrier synchronization includes:
performing barrier synchronization of all threads of the plurality of threads until transactions being processed when the abort is detected are all aborted.

4. The method according to claim 1, wherein the performance of barrier synchronization includes:
performing barrier synchronization of all threads of the plurality of threads until transactions in all but one or more threads coming later in order of execution of transactions being processed when the abort is detected are all committed.

5. The method according to claim 1, wherein the performance of barrier synchronization includes:
performing barrier synchronization of all the plurality of threads until transactions in all but one or more threads coming later in order of execution of transactions being processed when the abort is detected are all aborted.

6. The method according claim 1, of the method further comprising:
measuring an abort rate, and
repeating the detection and the performance of barrier synchronization as long as the abort rate is lower than a predetermined threshold value.

7. The method according to claim 6, wherein
the step of measuring the abort rate is executed, in response to the detection of the abort, in response to at least one of the following: (i) completion of the barrier synchronization, (ii) at predetermined time intervals, and/or (iii) a predetermined amount of transactions have been processed.

8. A computer for executing ordered transactions in a plurality of threads, comprising:
an abort detector structured and/or programmed to detect that an abort has occurred in at least one of transactions of the respective threads; and
a barrier synchronator programmed and/or structured to perform barrier synchronization of at least two threads including a thread in which the abort is detected.

9. The computer according to claim 8, wherein the barrier synchronator performs barrier synchronization of all the plurality of threads until transactions being processed when the abort is detected are all committed.

10. The computer according to claim 8, wherein the barrier synchronator performs barrier synchronization of all the plurality of threads until transactions being processed when the abort is detected are all aborted.

11. The computer according to claim 8, wherein the barrier synchronator performs barrier synchronization of all the plurality of threads until transactions in all but one or more threads coming later in order of execution of transactions being processed when the abort is detected are all committed.

12. The computer according to claim 8, wherein the barrier synchronator performs barrier synchronization of all the plurality of threads until transactions in all but one or more threads coming later in order of execution of transactions being processed when the abort is detected are all aborted.

13. The computer according to claim 8 wherein
the computer further comprises abort rate measurer structured and/or programmed to measure an abort rate, and
the computer repeats the detection and the barrier synchronization when the abort rate, measured by the abort rate measurer, is lower than a predetermined threshold value.

14. The computer according to claim 13, wherein the abort rate measurer measures the abort rate in response to the detection of the abort, in response to completion of the barrier synchronization, at predetermined time intervals, or in response to a fact that a predetermined transaction amount is processed.

15. A computer program for executing ordered transactions in a plurality of threads, causing a computer to execute each step of the method according to claim 1.
